(19) United States
(12) Patent Application Publication
(10) Pub. No.: US 2017/0120124 A1
(43) Pub. Date: May 4, 2017

(54) SWING ANALYSIS APPARATUS, SWING ANALYSIS SYSTEM, SWING ANALYSIS METHOD, SWING ANALYSIS PROGRAM, RECORDING MEDIUM, AND SWING DISPLAY APPARATUS

(71) Applicant: SEIKO EPSON CORPORATION, Tokyo (JP)

(72) Inventor: Norihisa HAGIWARA, Hachioji-shi (JP)

(73) Assignee: SEIKO EPSON CORPORATION, Tokyo (JP)

(21) Appl. No.: 15/293,121

(22) Filed: Oct. 13, 2016

(30) Foreign Application Priority Data
Nov. 4, 2015 (JP) 2015-216760

(51) Int. Cl. A63B 60/46; A63B 24/00; A63B 71/06; G09B 19/00

(52) U.S. Cl. CPC A63B 60/46; G09B 19/0038; A63B 24/0006; A63B 71/0622; A63B 2102/32

(57) ABSTRACT

A swing analysis apparatus includes an acquisition portion that acquires time-series data regarding positions of a portion moved due to a swing, a projection portion that projects the time-series data onto a virtual plane specified by a first axis along a target hit ball direction and a second axis along a longitudinal direction of an exercise equipment before the swing is started, a division portion that divides the projected time-series data into a plurality of sections, and a fitting portion that fits the time-series data to a circular arc for each section, and calculates at least one of a center and a radius of the circular arc for each section.

### BACKGROUND

1. Technical Field

The present invention relates to a swing analysis apparatus, a swing analysis system, a swing analysis method, a swing analysis program, a recording medium, and a swing display apparatus.

2. Related Art

JP-A-5-118818 discloses a golf selection system in which a plurality of point sequences indicating a swing trajectory of a target object are incorporated on three-dimensional coordinates in a time series by an imaging apparatus, and the rotation center or a rotation radius of a swing is analyzed. A user of the system can determine that the swing trajectory was favorable if deviation of the rotation center or deviation of the rotation radius is small.

However, in the system of the related art, when an index indicating deviation of the rotation center or deviation of a rotation radius is calculated, point sequences are projected onto a plane (refer to FIG. 2(b) of JP-A-5-118818; a so-called swing plane) obtained by averaging differences in balance of the point sequences, and, thus, even if an attitude of the swing plane is not appropriate, there is a high probability that this may not be reflected in an index.

In the present specification, a trajectory of a portion (a user's body or a predetermined portion of an exercise equipment) moved due to a swing is referred to as a “swing trajectory”, and a plane on which the swing trajectory is present is referred to as a “swing plane”.

### SUMMARY

An advantage of some aspects of the invention is to provide a swing analysis apparatus, a swing analysis system, a swing analysis method, a swing analysis program, a recording medium, and a swing display apparatus, capable of obtaining an index reliably reflecting quality of a swing trajectory.

The invention can be implemented as the following forms or application examples.

### Application Example 1

A swing analysis apparatus according to this application example includes an acquisition portion that acquires time-series data regarding positions of a predetermined portion of an exercise equipment moved due to a swing; a projection portion that projects the time-series data onto a virtual plane specified by a first axis along a target hit ball direction and a second axis along a longitudinal direction of the exercise equipment before the swing is started; a division portion that divides the projected time-series data into a plurality of sections; and a fitting portion that fits the projected time-series data to a circular arc for each section, and calculates at least one of a center and a radius of the circular arc for each section.

Therefore, the index (at least one of the center and the radius of the circular arc of each section) related to the application example reliably reflects quality of a swing trajectory. Thus, according to the index (at least one of the center and the radius of the circular arc of each section) related to the application example, for example, it is also possible to perform swing diagnosis with high accuracy.

### Application Example 2

In the swing analysis apparatus according to the application example, the division portion may provide portions overlapping each other in a boundary region of sections adjacent to each other among the plurality of sections.

Therefore, the swing analysis apparatus according to the application example may generate circular arcs of the plurality of sections as a consecutive curve. This curve represents an outline of a swing trajectory.

### Application Example 3

In the swing analysis apparatus according to the application example, the division portion may set spatial lengths of the plurality of sections to be the same as each other.

Therefore, the swing analysis apparatus according to the application example can make a length of each circular arc of the plurality of sections uniform. Since a speed of the portion during the swing is not uniform, in a case where temporal lengths of the plurality of sections are set to be the same as each other, there is a probability that a length of each circular arc of the plurality of sections may be considerably nonuniform.

### Application Example 4

In the swing analysis apparatus according to the application example, the division portion may divide a sum of intervals of positions adjacent to each other in the projected time-series data by a predetermined number, so as to determine a length of each of the plurality of sections.

Therefore, the swing analysis apparatus according to the application example can reliably set spatial lengths of the plurality of sections to be the same as each other.

### Application Example 5

In the swing analysis apparatus according to the application example, the fitting portion may apply a least square method to the fitting.

Therefore, the swing analysis apparatus according to the application example can increase the reliability by using the well-known method for the fitting.

### Application Example 6

In the swing analysis apparatus according to the application example, the acquisition portion may reduce the number of samples of positions included in the time-series data.

The swing analysis apparatus according to the application example can reduce a calculation amount required in processes such as projection, division, and fitting.

### Application Example 7

The swing analysis apparatus according to the application example may further include a presentation portion that presents, for each section, at least either centers or radii of the circular arcs of the plurality of sections.

As a variation in at least one of the center and the radius of the circular arc of the section is reduced, a swing trajectory may become more favorable. Therefore, the swing analysis apparatus according to the application example can specifically present quality of a swing trajectory. The swing analysis apparatus according to the application example may present how at least one of the center and the radius of the circular arc changes over time.

### Application Example 8

In the swing analysis apparatus according to the application example, the presentation portion may present a standard deviation of at least either centers or radii of the circular arcs.

Therefore, the swing analysis apparatus according to the application example can quantitatively present a variation in at least one of the center and the radius of the circular arc.

### Application Example 9

In the swing analysis apparatus according to the application example, the presentation portion may present a curve indicating the circular arc.

Therefore, the swing analysis apparatus according to the application example can present an outline of a swing trajectory.

### Application Example 10

In the swing analysis apparatus according to the application example, the presentation portion may display, as the radius of the circular arc, a line segment reaching the center of the circular arc of the section from a boundary of at least one of the plurality of sections.

Therefore, the swing analysis apparatus according to the application example can present a boundary of the section and the circular arc radius of the section by using a common line segment.

### Application Example 11

In the swing analysis apparatus according to the application example, the time-series data may be at least one of time-series data from starting of the swing to impact, time-series data from starting of the swing to a top, and time-series data from the top to the impact.

Therefore, the swing analysis apparatus according to the application example can set, as a fitting target or a presentation target, a period from a predetermined timing of the swing to another predetermined timing thereof.

### Application Example 12

In the swing analysis apparatus according to the application example, at least one of the time-series data and the virtual plane may be calculated on the basis of outputs from an inertial sensor.

The inertial sensor can accurately measure a position of a portion moved due to a swing. Therefore, the swing analysis apparatus according to the application example can accurately calculate an index compared with a case of calculating an index on the basis of a swing image or the like.

### Application Example 13

A swing analysis system according to this application example includes the swing analysis apparatus according to the application example; and the inertial sensor.

### Application Example 14

A swing analysis method according to this application example includes an acquisition procedure of acquiring time-series data regarding positions of a predetermined portion of an exercise equipment moved due to a swing; a projection procedure of projecting the time-series data onto a virtual plane specified by a first axis along a target hit ball direction and a second axis along a longitudinal direction of the exercise equipment before the swing is started; a division procedure of dividing the projected time-series data into a plurality of sections; and a fitting procedure of fitting the projected time-series data to a circular arc for each section, and calculating at least one of a center and a radius of the circular arc for each section.

Therefore, the index (at least one of the center and the radius of the circular arc of each section) related to the application example reliably reflects quality of a swing trajectory. Thus, according to the index (at least one of the center and the radius of the circular arc of each section) related to the application example, for example, it is also possible to perform swing diagnosis with high accuracy.

### Application Example 15

A swing analysis program according to this application example causes a computer to execute an acquisition procedure of acquiring time-series data regarding positions of a predetermined portion of an exercise equipment moved due to a swing; a projection procedure of projecting the time-series data onto a virtual plane specified by a first axis along a target hit ball direction and a second axis along a longitudinal direction of the exercise equipment before the swing is started; a division procedure of dividing the projected time-series data into a plurality of sections; and a fitting procedure of fitting the projected time-series data to a circular arc for each section, and calculating at least one of a center and a radius of the circular arc for each section.

Therefore, the index (at least one of the center and the radius of the circular arc of each section) related to the application example reliably reflects quality of a swing trajectory. Thus, according to the index (at least one of the center and the radius of the circular arc of each section) related to the application example, for example, it is also possible to perform swing diagnosis with high accuracy.

### Application Example 16

A recording medium according to this application example records a swing analysis program causing a computer to execute an acquisition procedure of acquiring time-series data regarding positions of a predetermined portion of an exercise equipment moved due to a swing; a projection procedure of projecting the time-series data onto a virtual plane specified by a first axis along a target hit ball direction and a second axis along a longitudinal direction of the exercise equipment before the swing is started; a division procedure of dividing the projected time-series data into a plurality of sections; and a fitting procedure of fitting the projected time-series data to a circular arc for each section, and calculating at least one of a center and a radius of the circular arc for each section.

Therefore, the index (at least one of the center and the radius of the circular arc of each section) related to the application example reliably reflects quality of a swing trajectory. Thus, according to the index (at least one of the center and the radius of the circular arc of each section) related to the application example, for example, it is also possible to perform swing diagnosis with high accuracy.

### Application Example 17

A swing display apparatus according to this application example displays a plurality of circular arcs based on a trajectory of a predetermined portion of an exercise equipment due to a swing, and at least one of a center and a radius of each of the plurality of circular arcs, in an overlapping manner with a reference plane specified in a standing still state of the exercise equipment.

### Application Example 18

In the swing display apparatus according to the application example, each of the circular arcs may be a curve to which a projection image obtained by projecting the trajectory onto the plane is fitted.

### Application Example 19

In the swing display apparatus according to the application example, the reference plane may be at least one of a first plane specified by a first axis along a target hit ball direction and a second axis along a longitudinal direction of the exercise equipment before the swing is started, a second plane including the first axis and forming a predetermined angle with the first plane, and a third plane parallel to the first plane.

### BRIEF DESCRIPTION OF THE DRAWINGS

The invention will be described with reference to the accompanying drawings, wherein like numbers reference like elements.

FIG. 1 is a diagram illustrating an outline of a swing analysis system of the present embodiment.

FIG. 2 is a diagram illustrating examples of a position at which and a direction in which a sensor unit is attached.

FIG. 3 is a diagram illustrating procedures of actions performed by a user until the user hits a ball.

FIG. 4 is a diagram illustrating an example of an input screen of physical information and golf club information.

FIG. 5 is a diagram illustrating a swing action.

FIG. 6 is a diagram illustrating a configuration example of the swing analysis system.

FIG. 7 is a plan view in which a golf club and the sensor unit are viewed from a negative side of an X axis during standing still of the user.

FIG. 8 is a view in which a sectional view of a shaft plane which is cut in a YZ plane is viewed from the negative side of the X axis.

FIG. 9 is a diagram for explaining an operation of a projection portion.

FIG. 10 is a diagram for explaining operations of a division portion and a fitting portion.

FIG. 11 illustrates an example of a display screen of swing analysis data including an index calculated through circular arc fitting (a target period is a backswing period).

FIG. 12 illustrates another example of a display screen of swing analysis data including an index calculated through circular arc fitting (a target period is a downswing period).

FIG. 13 is a flowchart illustrating examples of procedures of a swing analysis process in the embodiment.

FIG. 14 is a flowchart illustrating examples of procedures of a circular arc fitting process.

FIG. 15 illustrates still another example of a display screen of swing analysis data including an index calculated through circular arc fitting (a target period is a backswing period).

FIG. 16 illustrates another example of a display screen of swing analysis data including an index calculated through circular arc fitting (a target period is a downswing period).

FIG. 17 is a flowchart illustrating examples of procedures of a swing analysis process in a modification example.

FIG. 18 illustrates an example of a display screen of swing analysis data including an index calculated through circular arc fitting in a modification example (a target period is the entire swing period, and the number of sections is two).

### DESCRIPTION OF EXEMPLARY EMBODIMENTS

Hereinafter, preferred embodiments of the invention will be described with reference to the drawings. The embodiments described below are not intended to improperly limit the content of the invention disclosed in the appended claims. In addition, all constituent elements described below are not essential constituent elements of the invention. Hereinafter, a swing analysis system performing analysis of a golf swing will be described as an example.

### 1. First Embodiment

### 1-1. Outline of Swing Analysis System

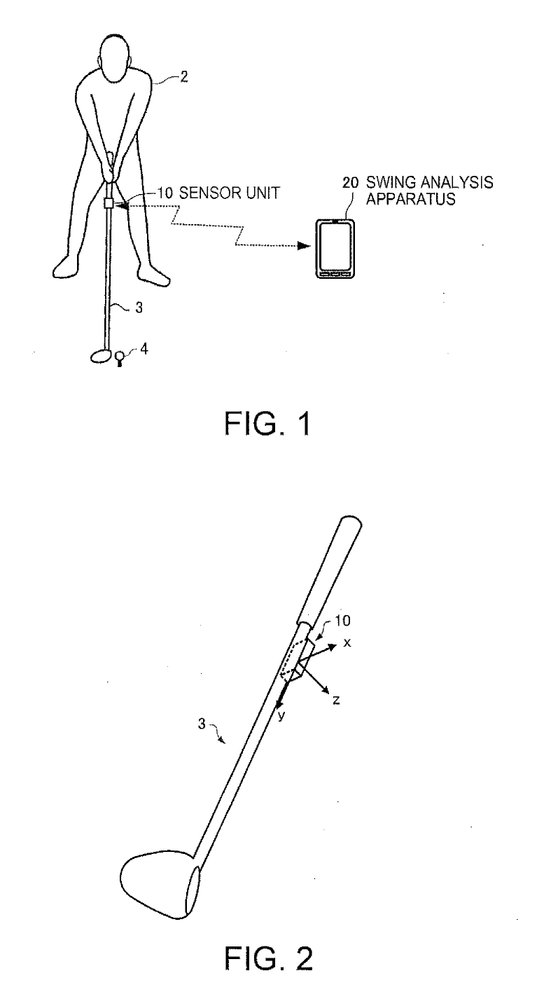

FIG. 1 is a diagram illustrating an outline of a swing analysis system of the present embodiment.

As illustrated in FIG. 1, a swing analysis system 1 of the present embodiment is configured to include a sensor unit 10 (an example of an inertial sensor), and a swing analysis apparatus 20.

The sensor unit 10 can measure acceleration generated in each axial direction of three axes and angular velocity generated about each of the three axes, and is attached to a golf club 3 (an example of an exercise equipment).

### 1-2. Attachment Examples of Sensor Unit

FIG. 2 is a diagram illustrating examples of a position at which and a direction in which the sensor unit 10 is attached to the golf club 3.

As illustrated in FIG. 2, an attitude of the sensor unit 10 attached to the golf club 3 is set so that one axis (here, a y axis) of three detection axes (an x axis, the y axis, and a z axis) of the sensor unit 10 matches a longitudinal direction of the shaft of the golf club 3.

An attitude of another axis (here, the x axis) of the sensor unit 10 with respect to the golf club 3 is an attitude in which the x axis is along a target line (an example of a first axis; target hit ball direction). The target line is, for example, a line obtained by projecting a surface normal at a ball hitting point of a face surface of the golf club 3 onto a horizontal plane.

Preferably, the sensor unit 10 is attached to the golf club 3 at a position close to a grip to which impact during ball hitting is hardly forwarded and centrifugal force is hardly applied during a swing. The “shaft” mentioned here is a shaft portion other than a head of the golf club 3 and also includes the grip. The “face surface” indicates a ball hitting surface of the golf club 3.

### 1-3. User's Actions

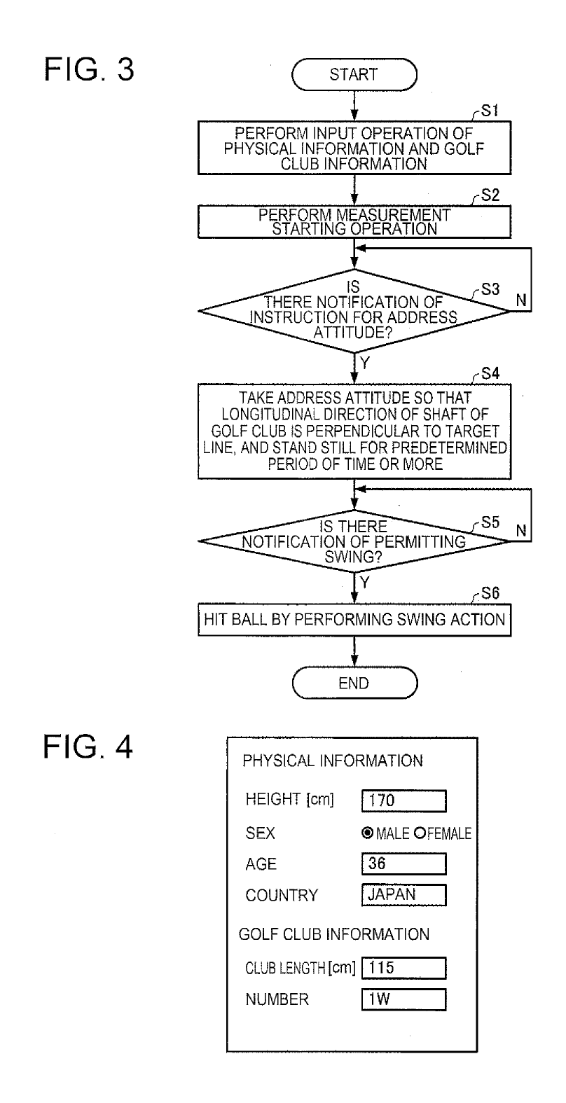

FIG. 3 is a diagram illustrating procedures of actions performed by a user 2 until the user hits the ball. Hereinafter, respective steps in FIG. 3 will be described in order.

Step S1: The user 2 performs an input operation of physical information of the user 2, information (golf club information) regarding the golf club 3 used by the user 2, and the like via the swing analysis apparatus 20. The physical information includes at least one of information regarding a height, a length of the arm, and a length of the leg of the user 2, and may further include information regarding a sex or other information. The golf club information includes at least one of information regarding a length (club length) of the golf club 3 and the type (number) of golf club 3.

Step S2: The user 2 performs a measurement starting operation (an operation for starting measurement in the sensor unit 10) via the swing analysis apparatus 20. The swing analysis apparatus 20 transmits a measurement starting command to the sensor unit 10, and the sensor unit 10 receives the measurement starting command and starts measurement of three-axis accelerations and three-axis angular velocities. The sensor unit 10 measures three-axis accelerations and three-axis angular velocities in a predetermined sampling cycle (for example, Δt=1 ms), and sequentially transmits the measured data to the swing analysis apparatus 20. Communication between the sensor unit 10 and the swing analysis apparatus 20 is wireless communication or wired communication.

Step S3: The user 2 determines whether or not a notification (for example, a notification using a voice) of giving an instruction for taking an address attitude has been received from the swing analysis apparatus 20, transitions to step S4 if the notification has been received (Y in S3), and waits if the notification has not been received (N in S3).

Step S4: The user 2 takes an address attitude so that the longitudinal direction of the shaft of the golf club 3 is perpendicular to a target line (target hit ball direction), and stands still for a predetermined period of time.

Step S5: The user 2 determines whether or not a notification (for example, a notification using a voice) of permitting a swing has been received from the swing analysis apparatus 20, transitions to step 96 if the notification has been received (Y in 95), and keeps standing still if the notification has not been received (N in S5).

Step S6: The user 2 performs a swing action from the address attitude so as to hit a golf ball 4. Thereafter, the swing analysis apparatus 20 analyzes the swing action in which the user 2 has hit the ball by using the golf club 3 on the basis of measured data from the sensor unit 10.

### 1-4. Input Screen

FIG. 4 is a diagram illustrating an example of an input screen of physical information and golf club information, displayed on the swing analysis apparatus 20.

The user 2 inputs physical information such as a height, a sex, an age, and a country, and inputs golf club information such as a club length (a length of the shaft), and a number on the input screen illustrated in FIG. 4. Information included in the physical information is not limited thereto, and, the physical information may include, for example, at least one of information regarding a length of the arm and a length of the leg instead of or along with the height. Similarly, information included in the golf club information is not limited thereto, and, for example, the golf club information may not include at least one of information regarding the club length and the number, and may include other information.

### 1-5. Swing Action

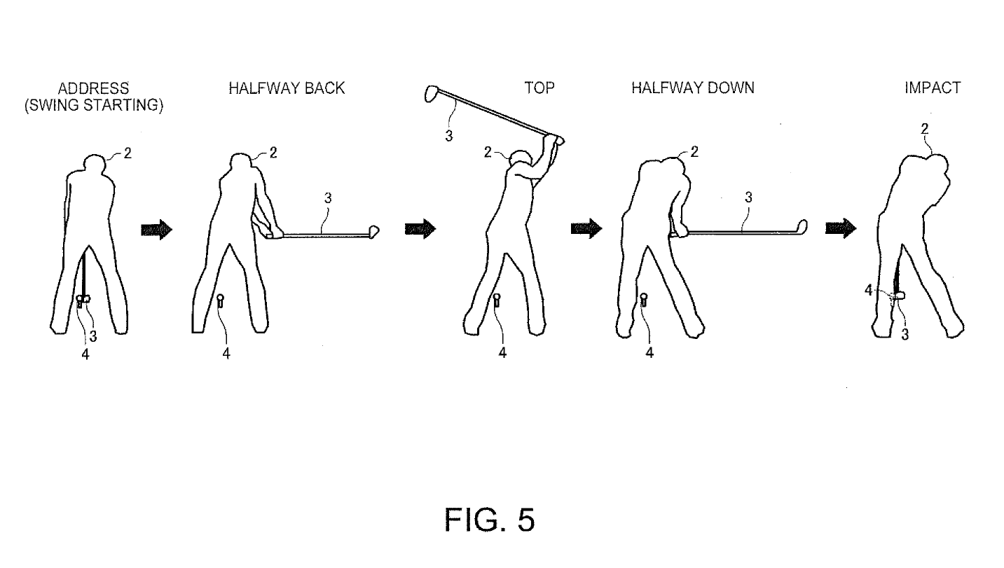

FIG. 5 is a diagram for explaining a swing action.

As illustrated in FIG. 5, the swing action performed by the user 2 includes an action reaching impact (ball hitting) at which the golf ball 4 is hit through respective states of halfway back at which the shaft of the golf club 3 becomes horizontal during a backswing after starting a swing (backswing), a top at which the swing changes from the backswing to a downswing, and halfway down at which the shaft of the golf club 3 becomes horizontal during the downswing.

### 1-6. Configuration of Swing Analysis System

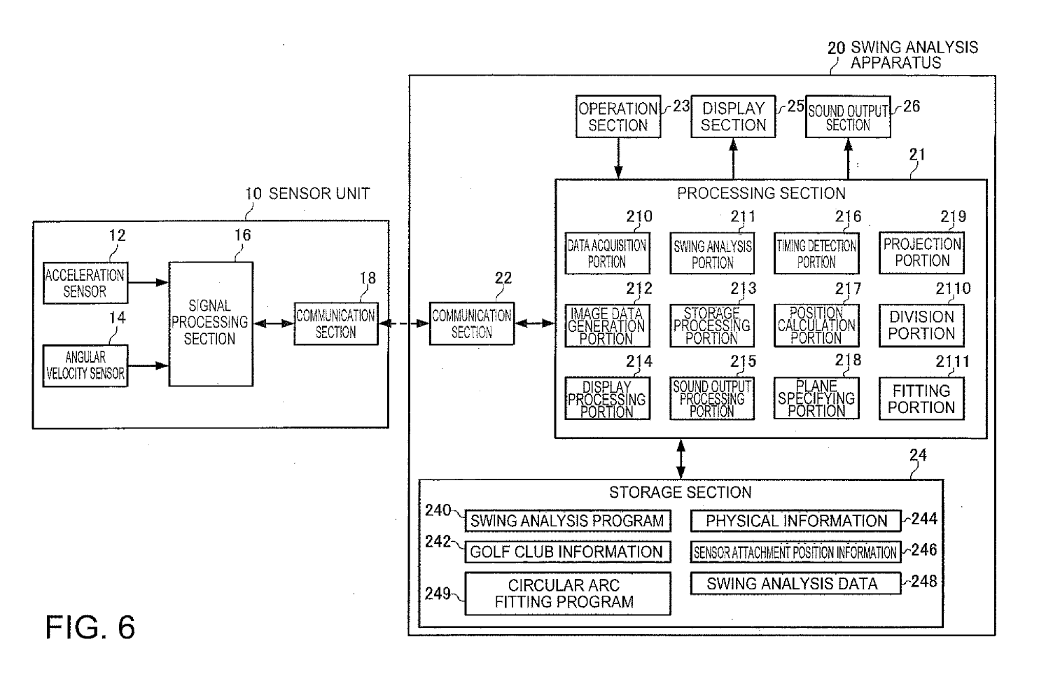

FIG. 6 is a diagram illustrating a configuration example of the swing analysis system.

As illustrated in FIG. 6, in the present embodiment, the sensor unit 10 is configured to include an acceleration sensor 12, an angular velocity sensor 14, a signal processing section 16, and a communication section 18. However, the sensor unit 10 may have a configuration in which some of the constituent elements are deleted or changed as appropriate, or may have a configuration in which other constituent elements are added thereto.

The acceleration sensor 12 measures respective accelerations in three axial directions which intersect (ideally, orthogonal to) each other, and outputs digital signals (acceleration data) corresponding to magnitudes and directions of the measured three-axis accelerations.

The angular velocity sensor 14 measures respective angular velocities in three axial directions which intersect (ideally, orthogonal to) each other, and outputs digital signals (angular velocity data) corresponding to magnitudes and directions of the measured three-axis angular velocities.

The signal processing section 16 receives the acceleration data and the angular velocity data from the acceleration sensor 12 and the angular velocity sensor 14, respectively, stores the data in a storage portion (not illustrated), adds time information to the stored measured data (acceleration data and angular velocity data) so as to generate packet data conforming to a communication format, and outputs the packet data to the communication section 18.

Ideally, the acceleration sensor 12 and the angular velocity sensor 14 are provided in the sensor unit 10 so that the three axes thereof match three axes (an x axis, a y axis, and a z axis) of an orthogonal coordinate system (sensor coordinate system) defined for the sensor unit 10, but, actually, errors occur in installation angles. Therefore, the signal processing section 16 performs a process of converting the acceleration data and the angular velocity data into data in the xyz coordinate system by using a correction parameter which is calculated in advance according to the installation angle errors.

The signal processing section 16 may perform a process of correcting the temperatures of the acceleration sensor 12 and the angular velocity sensor 14. The acceleration sensor 12 and the angular velocity sensor 14 may have a temperature correction function.

The acceleration sensor 12 and the angular velocity sensor 14 may output analog signals, and, in this case, the signal processing section 16 may A/D convert an output signal from the acceleration sensor 12 and an output signal from the angular velocity sensor 14 so as to generate measured data (acceleration data and angular velocity data), and may generate communication packet data by using the data.

The communication section 18 performs a process of transmitting packet data received from the signal processing section 16 to the swing analysis apparatus 20, or a process of receiving various control commands such as a measurement starting command from the swing analysis apparatus 20 and sending the control command to the signal processing section 16. The signal processing section 16 performs various processes corresponding to control commands.

As illustrated in FIG. 6, the swing analysis apparatus 20 is configured to include a processing section 21 (an example of a computer), a communication section 22, an operation section 23, a storage section 24, a display section 25 (an example of a presentation portion), and a sound output section 26 (an example of a presentation portion). However, the swing analysis apparatus 20 may have a configuration in which some of the constituent elements are deleted or changed as appropriate, or may have a configuration in which other constituent elements are added thereto.

The communication section 22 performs a process of receiving packet data transmitted from the sensor unit 10 and sending the packet data to the processing section 21, or a process of transmitting a control command from the processing section 21 to the sensor unit 10.

The operation section 23 performs a process of acquiring operation data from the user 2 and sending the operation data to the processing section 21. The operation section 23 may be, for example, a touch panel type display, a button, a key, or a microphone.

The storage section 24 is constituted of, for example, various IC memories such as a read only memory (ROM), a flash ROM, and a random access memory (RAM), or a recording medium such as a hard disk or a memory card. The storage section 24 stores a program for the processing section 21 performing various calculation processes or a control process, or various programs or data for realizing application functions.

In the present embodiment, the storage section 24 stores a swing analysis program 240 which is read by the processing section 21 and executes a swing analysis process, and a circular arc fitting program 249 which is read by the processing section 21 and executes a circular arc fitting process (an example of a swing analysis method). The swing analysis program 240 and the circular arc fitting program 249 may be stored in a nonvolatile recording medium (computer readable recording medium) in advance, and may be received from a server (not illustrated) by the processing section 21 via a network so as to be stored in the storage section 24.

In the present embodiment, the storage section 24 stores golf club information 242, physical information 244, sensor attachment position information 246, and swing analysis data 248. For example, the user 2 may operate the operation section 23 so as to input specification information regarding the golf club 3 to be used (for example, at least some information such as information regarding a length of the shaft, a position of the centroid thereof, a lie angle, a face angle, a loft angle, and the like) from an input screen, and the input specification information may be used as the golf club information 242. Alternatively, in step S1, the user 2 may input type numbers of the golf club 3 (alternatively, selects a type number from a type number list) and specification information of an input type number among the specification information for each type number stored in the storage section 24 in advance may be used as the golf club information 242.

For example, the user 2 may input physical information by operating the operation section 23 from an input screen, and the input physical information may be used as the physical information 244. For example, in step S1, the user 2 may input a distance between an attachment position of the sensor unit 10 and a grip end of the golf club 3 by operating the operation section 23, and the input distance information may be used as the sensor attachment position information 246. Alternatively, assuming that the sensor unit 10 may be attached at a defined predetermined position (for example, a distance of 20 cm from the grip end), and thus information regarding the predetermined position may be stored as the sensor attachment position information 246 in advance.

The swing analysis data 248 is data including information regarding a swing analysis processing result (index) in the processing section 21 (swing analysis portion 211) along with a time point (date and time) at which a swing was performed, identification information or a sex of the user 2, and the type of golf club 3. In the present embodiment, the index also includes an index calculated through circular arc fitting which will be described later. Conditions applied to circular arc fitting which will be described later are also written in the swing analysis data 248.

The storage section 24 is used as a work area of the processing section 21, and temporarily stores data which is input from the operation section 23, results of calculation executed by the processing section 21 according to various programs, and the like. The storage section 24 may store data which is required to be preserved for a long period of time among data items generated through processing in the processing section 21.

The display section 25 displays a processing result in the processing section 21 as text, a graph, a table, animation, and other images. The display section 25 may be, for example, a CRT, an LCD, a touch panel type display, and a head mounted display (HMD). A single touch panel type display may realize functions of the operation section 23 and the display section 25.

The sound output section 26 outputs a processing result in the processing section 21 as a sound such as a voice or a buzzer sound. The sound output section 26 may be, for example, a speaker or a buzzer.

The processing section 21 performs a process of transmitting a control command to the sensor unit 10 via the communication section 22, or various computation processes on data which is received from the sensor unit 10 via the communication section 22, according to various programs. The processing section 21 performs other various control processes.

Particularly, in the present embodiment, by executing the swing analysis program 240 or the circular arc fitting program 249 (an example of a swing analysis program), the processing section 21 functions as a swing analysis portion 211, a timing detection portion 216, a position calculation portion 217 (an example of an acquisition portion), a plane specifying portion 218, a projection portion 219, a division portion 2110, and a fitting portion 2111. The processing section 21 appropriately functions as a data acquisition portion 210, an image data generation portion 212, a storage processing portion 213, a display processing portion 214, and a sound output processing portion 215.

The data acquisition portion 210 performs a process of receiving packet data which is received from the sensor unit 10 by the communication section 22, acquiring time information and measured data from the received packet data, and sending the time information and the measured data to the storage processing portion 213.

The storage processing portion 213 performs read/write processes of various programs or various data for the storage section 24. The storage processing portion 213 performs not only the process of storing the time information and the measured data received from the data acquisition portion 210 in the storage section 24 in correlation with each other, but also a process of storing various pieces of information calculated by the swing analysis portion 211, the swing analysis data 248, or the like in the storage section 24.

The swing analysis portion 211 analyzes a swing action of the user 2 by using the measured data (the measured data stored in the storage section 24) output from the sensor unit 10, the data from the operation section 23, or the like, so as to generate the swing analysis data 248 including a time point (date and time) at which the swing was performed, identification information or a sex of the user 2, the type of golf club 3, and an index calculated through circular arc fitting, and preserves the swing analysis data in the storage section 24 or displays the swing analysis data on the display section 25.

The swing analysis portion 211 writes conditions applied to circular arc fitting which will be described later and indexes calculated through the circular arc fitting in the swing analysis data 248 in correlation with each other.

The conditions applied to the circular arc fitting are, for example, a portion (target portion) as a target of the circular arc fitting, a period (target period) of a swing as a target of the circular arc fitting, and a boundary between sections set in the circular arc fitting.

In the present embodiment, a target portion of the circular arc fitting is assumed to be the head of the golf club 3. In the present embodiment, a target period of the circular arc fitting is assumed to be two periods such as a period from swing starting to a top (backswing) and a period from the top to impact (downswing). In the present embodiment, indexes calculated through the circular arc fitting are assumed to be four types of indexes such as a circular arc center of each section, a circular arc radius of each section, a standard deviation of the circular arc center, and a standard deviation of the circular arc radii.

The image data generation portion 212 performs a process of generating image data corresponding to an image displayed on the display section 25. For example, the image data generation portion 212 generates image data on the basis of various pieces of information received by the data acquisition portion 210.

The display processing portion 214 performs a process of displaying various images (including text, symbols, and the like in addition to an image corresponding to the image data generated by the image data generation portion 212) on the display section 25. For example, the display processing portion 214 displays various screens on the display section 25 on the basis of the image data generated by the image data generation portion 212. For example, the image data generation portion 212 may display an image, text, or the like for notifying the user 2 on the display section 25. For example, the display processing portion 214 may display text information such as text or symbols indicating an analysis result (at least some of the swing analysis data 248) in the swing analysis portion 211 on the display section 25 automatically or in response to an input operation performed by the user 2 after a swing action of the user 2 is completed. Alternatively, a display section may be provided in the sensor unit 10, and the display processing portion 214 may transmit image data to the sensor unit 10 via the communication section 22, and various images, text, or the like may be displayed on the display section of the sensor unit 10.

The sound output processing portion 215 performs a process of outputting various sounds (including voices, buzzer sounds, and the like) from the sound output section 26. For example, the sound output processing portion 215 may output a sound for notifying the user 2 from the sound output section 26. For example, the sound output processing portion 215 may output a sound or a voice indicating an analysis result (at least some of the swing analysis data 248) in the swing analysis portion 211 from the sound output section 26 automatically or in response to an input operation performed by the user 2 after a swing action of the user 2 is completed. Alternatively, a sound output section may be provided in the sensor unit 10, and the sound output processing portion 215 may transmit various items of sound data or voice data to the sensor unit 10 via the communication section 22, and may output various sounds or voices from the sound output section of the sensor unit 10.

A vibration mechanism may be provided in the swing analysis apparatus 20 or the sensor unit 10, and various pieces of information may be converted into pieces of vibration information by the vibration mechanism so as to be presented to the user 2.

The timing detection portion 216 detects a timing of each of swing starting, a top, and impact, on the basis of measured data output from the sensor unit 10. A method of detecting such a timing will be described later.

The position calculation portion 217 (an example of an acquisition portion) sets a global coordinate system on the basis of the measured data output from the sensor unit 10, and represents a position and an attitude of the sensor unit 10 at each time point t in the global coordinate system. Each time point t is time points t=0, t=Δt, t=2Δt, t=3Δt, . . . which are deviated by the sampling cycle Δt. A method of setting the global coordinate system, and a method of calculating a position and an attitude of the sensor unit 10 will be described later. The position calculation portion 217 calculates a position of a predetermined portion of the golf club 3 at the time point t on the basis of a position and an attitude of the sensor unit 10 at the time point t. A position of the head of the golf club 3 may be calculated on the basis of a positional relationship from an attachment position of the sensor unit 10 to the head, a position of the sensor unit 10, and an attitude of the sensor unit 10.

In the present embodiment, data (time-series data) in which positions of the head at respective time points are arranged in order of the time points is used for the circular arc fitting which will be described later. In the time-series data used for the circular arc fitting in the present embodiment, time information may not be added to each position.

The position calculation portion 217 also performs a process of extracting time-series data in a target period from the time-series data, and a process of reducing the number of samples of positions included in the extracted time-series data. For example, the position calculation portion 217 divides the time-series data into small sections (for example, 128 sections) of a predetermined number with the same time interval, and uses data (time-series data formed of 128 positions) in which average positions (or representative positions) of the respective small sections are arranged, as time-series data from which the number of samples is reduced. As mentioned above, if the number of samples of the time-series data is reduced, it is possible to reduce a calculation amount necessary in each process of projection (which will be described later) of the time-series data, division (which will be described later) of the time-series data, and circular arc fitting (which will be described later) of the time-series data.

For example, in a case where a period length of a backswing is 1500 msec, a period length of a downswing is 500 msec, and a sampling frequency is 1000 Hz, the number of samples of positions included in time-series data in the backswing period is 1500, and the number of samples of positions included in time-series data in the downswing period is 500. Therefore, according to the above-described reduction procedure, the number of samples in the time-series data in the backswing period is reduced from 1500 to 128, and the number of samples in the time-series data in the downswing period is reduced from 500 to 128.

The plane specifying portion 218 specifies a shaft plane (an example of a virtual plane) on the basis of measured data (acceleration data) output from the sensor unit 10 when the user 2 takes an address attitude. A method of specifying the shaft plane will be described later. FIG. 8 illustrates an example of a shaft plane SP in a plan view (on a YZ plane) from a reverse target direction of a right-handed user 2.

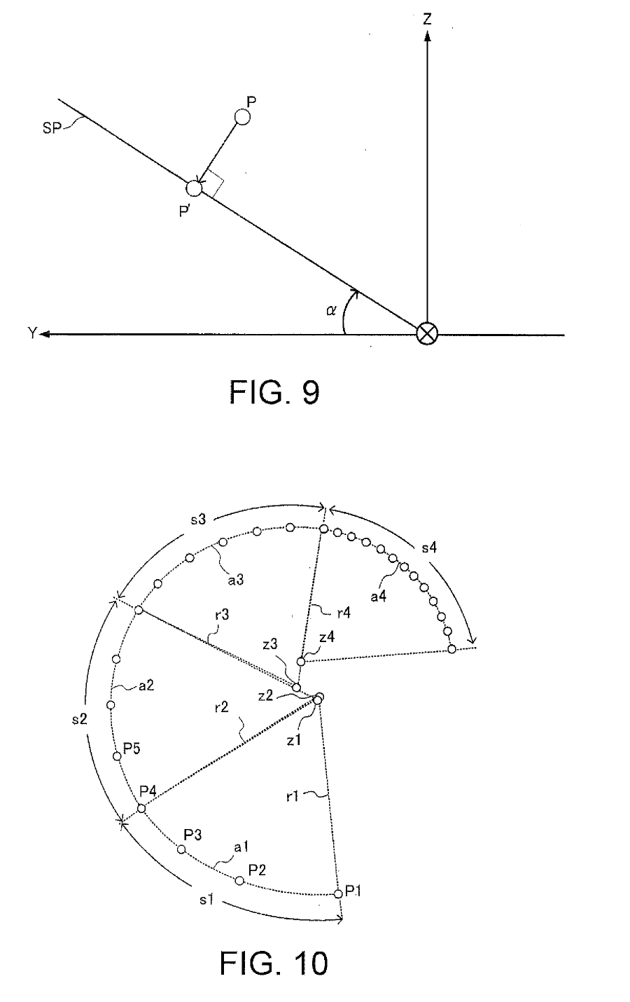

The projection portion 219 orthographically projects (vertically projects) each position included in time-series data in a target period onto the shaft plane SP, and calculates coordinates of a projection destination in the shaft plane SP. As illustrated in FIG. 9, a projection destination P′ of a position P included in time-series data is an intersection of a perpendicular line drawn onto the shaft plane SP from the position P.

FIG. 10 schematically illustrates a state in which time-series data in the backswing period is projected onto the shaft plane SP. The reference signs P1, P2, P3, . . . in FIG. 10 indicate respective positions included in the time-series data, and numbers 1, 2, 3, . . . added to the letter P indicate sample numbers (order of time points).

If a swing is favorable, a trajectory (a trajectory of the head projected onto a swing plane) of the head drawn by time-series data in a space before being projected onto the shaft plane SP generally has an elliptical shape, but a trajectory (a trajectory of the head projected onto the shaft plane) of the head drawn in the shaft plane SP by time-series data projected onto the shaft plane SP may be close to a circular shape as illustrated in FIG. 10 (here, the “circular shape” is assumed to include both of a concentric circle and a true circle).

The division portion 2110 divides the time-series data projected onto the shaft plane SP into N (where N is an integer of 1 or greater; here, N=4) sections s1, s2, s3 and s4 as illustrated in FIG. 10. The plurality of separate sections s1, s2, s3 and s4 are used as the units of circular arc fitting.

The division portion 2110 sets spatial lengths of the plurality of sections s1, s2, s3 and s4 to be the same as each other. For this, for example, the division portion 2110 determines, as a length of each of the plurality of sections, a value of L/N obtained by dividing a sum L of distances between positions adjacent to each other in the time-series data projected onto the shaft plane SP by N.

The division portion 2110 may provide a portion overlapping a boundary region between sections adjacent to each other among the plurality of sections. For better understanding in FIG. 10, a length of an overlapping portion at the boundary of the sections corresponds to a single sample, but more lengths of overlapping portions may be provided. If the overlapping portion is provided as mentioned above, a plurality of circular arcs obtained through circular arc fitting can be formed as curves which are continuously smoothly connected to each other.

As illustrated in FIG. 10, the fitting portion 2111 fits time-series data included in the section s1, time-series data included in the section s2, time-series data included in the section s3, and time-series data included in the section s4 to circular arcs, respectively (circular arc fitting). Details of the circular arc fitting will be described later.

Hereinafter, as illustrated in FIG. 10, a circular arc which fits the time-series data included in the section s1 is indicated by a1, a circular arc which fits the time-series data included in the section s2 is indicated by a2, a circular arc which fits the time-series data included in the section s3 is indicated by a3, and a circular arc which fits the time-series data included in the section s4 is indicated by a4.

The fitting portion 2111 calculates a central position (circular arc center) z1 of the circular arc a1, a radius (circular arc radius) r1 of the circular arc a1, a central position (circular arc center) z2 of the circular arc a2, a radius (circular arc radius) r2 of the circular arc a2, a central position (circular arc center) z3 of the circular arc a3, a radius (circular arc radius) r3 of the circular arc a3, a central position (circular arc center) z4 of the circular arc a4, and a radius (circular arc radius) r4 of the circular arc a4.

The fitting portion 2111 calculates the circular arc centers (z1, z2, z3, and z4) of the respective sections, the circular arc radii (r1, r2, r3, and r4) of the respective sections, a standard deviation σz of the circular arc centers of the plurality of sections, and a standard deviation σr of the circular arc radii of the plurality of sections.

The four types of indexes calculated through the above-described circular arc fitting, that is, the circular arc centers (z1, z2, z3, and z4) of the respective sections, the circular arc radii (r1, r2, r3, and r4) of the respective sections, the standard deviation σz of the circular arc centers, and the standard deviation σr of the circular arc radii are written in the swing analysis data 248.

The four types of indexes may be correlated with conditions for the circular arc fitting, that is, a target period (here, a backswing period or a downswing period), a target portion (here, the head), and information indicating boundaries of the plurality of sections s1, s2, s3 and s4.

### 1-7. Setting of Global Coordinate System

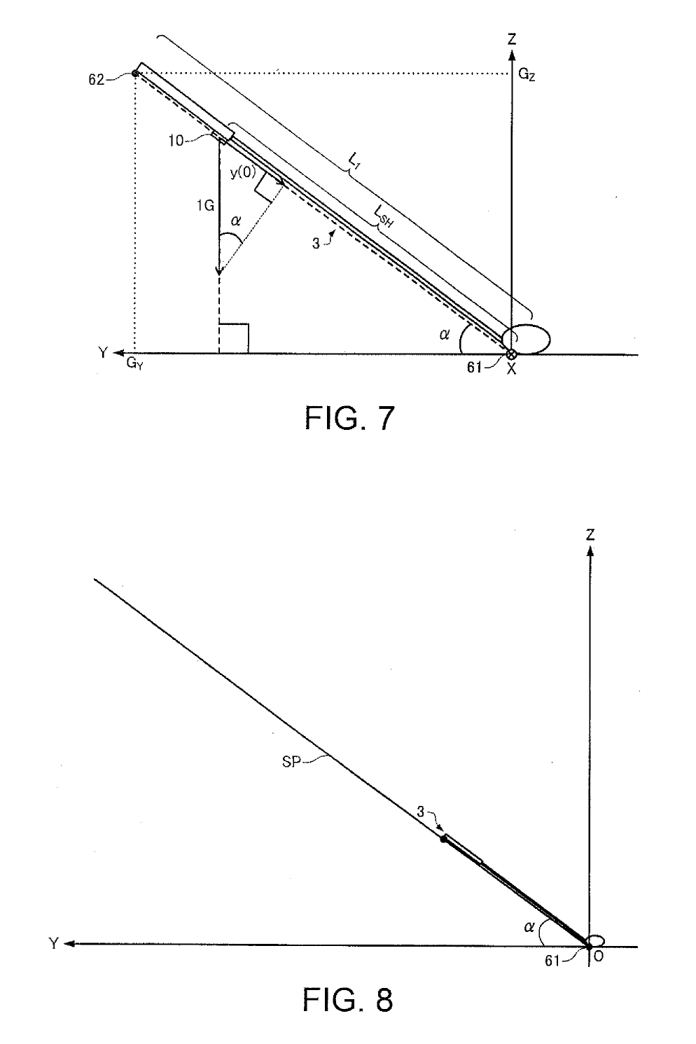

As illustrated in FIG. 7, when a position of the head of the golf club 3 at address (during standing still) is set to the origin, the position calculation portion 217 defines an XYZ coordinate system (global coordinate system) which has a target line indicating a target hit ball direction as an X axis, an axis on a horizontal plane which is perpendicular to the X axis as a Y axis, and a vertically upward direction (a direction opposite to the gravitational acceleration direction) as a Z axis. In order to calculate each index value, the position calculation portion 217 calculates a position and an attitude of the sensor unit 10 in a time series from the time of the address in the XYZ coordinate system (global coordinate system) by using measured data (acceleration data and angular velocity data) in the sensor unit 10.

### 1-8. Calculation of Position and Attitude of Sensor Unit

If the user 2 performs the action in step S4 in FIG. 3, first, the position calculation portion 217 determines that the user 2 stands still at an address attitude in a case where an amount of changes in acceleration data measured by the acceleration sensor 12 does not continuously exceed a threshold value for a predetermined period of time. Next, the position calculation portion 217 computes an offset amount included in the measured data by using the measured data (acceleration data and angular velocity data) for the predetermined period of time. Next, the position calculation portion 217 subtracts the offset amount from the measured data so as to perform bias correction, and computes a position and an attitude of the sensor unit 10 during a swing action of the user 2 (during the action in step S6 in FIG. 3) by using the bias-corrected measured data.

Specifically, first, the position calculation portion 217 computes a position (initial position) of the sensor unit 10 during standing still (at address) of the user 2 in the XYZ coordinate system (global coordinate system) by using the acceleration data measured by the acceleration sensor 12, the golf club information 242, and the sensor attachment position information 246.

FIG. 7 is a plan view in which the golf club 3 and the sensor unit 10 during standing still (at address) of the user 2 are viewed from a negative side of the X axis. The origin O (0,0,0) is set at a position 61 of the head of the golf club 3, and coordinates of a position 62 of a grip end are (0, G_{Y}, G_{Z}). Since the user 2 performs the action in step S4 in FIG. 3, the position 62 of the grip end or the initial position of the sensor unit 10 has an X coordinate of 0, and is present on the YZ plane. As illustrated in FIG. 7, the gravitational acceleration of 1G is applied to the sensor unit 10 during standing still of the user 2, and thus a relationship between a y axis acceleration y(0) measured by the sensor unit 10 and an inclined angle (an angle formed between the long axis of the shaft and the horizontal plane (XY plane)) α of the shaft of the golf club 3 is expressed by Equation (1).

y(0)=1G·sin α (1)

Therefore, the position calculation portion 217 can calculate an inclined angle α according to Equation (1) by using any acceleration data between any time points at address (during standing still).

Next, the position calculation portion 217 subtracts a distance L_{SG} between the sensor unit 10 and the grip end included in the sensor attachment position information 246 from a length L₁ of the shaft included in the golf club information 242, so as to obtain a distance L_{SH} between the sensor unit 10 and the head. The position calculation portion 217 sets, as the initial position of the sensor unit 10, a position separated by the distance L_{SH} from the position 61 (origin O) of the head in a direction (a negative direction of the y axis of the sensor unit 10) specified by the inclined angle α of the shaft.

The position calculation portion 217 integrates subsequent acceleration data so as to compute coordinates of a position from the initial position of the sensor unit 10 in a time series.

The position calculation portion 217 computes an attitude (initial attitude) of the sensor unit 10 during standing still (at address) of the user 2 in the XYZ coordinate system (global coordinate system) by using acceleration data measured by the acceleration sensor 12. Since the user 2 performs the action in step S4 in FIG. 3, the x axis of the sensor unit 10 matches the X axis of the XYZ coordinate system in terms of direction at address (during standing still) of the user 2, and the y axis of the sensor unit 10 is present on the YZ plane. Therefore, the position calculation portion 217 can specify the initial attitude of the sensor unit 10 on the basis of the inclined angle α of the shaft of the golf club 3.

The position calculation portion 217 computes changes in attitudes from the initial attitude of the sensor unit 10 in a time-series manner by performing rotation calculation using angular velocity data which is subsequently measured by the angular velocity sensor 14. An attitude of the sensor unit 10 may be expressed by, for example, rotation angles (a roll angle, a pitch angle, and a yaw angle) about the X axis, the Y axis, and the Z axis, or a quaternion.

The signal processing section 16 of the sensor unit 10 may compute an offset amount of measured data so as to perform bias correction on the measured data, and the acceleration sensor 12 and the angular velocity sensor 14 may have a bias correction function. In this case, it is not necessary for the position calculation portion 217 to perform bias correction on the measured data.

### 1-9. Detection of Timings of Swing Starting, Top, and Impact

First, the timing detection portion 216 detects a timing (impact timing) at which the user 2 hits a ball by using measured data. For example, the timing detection portion 216 may compute a combined value of measured data (acceleration data or angular velocity data), and may detect an impact timing (time point) on the basis of the combined value.

Specifically, first, the timing detection portion 216 computes a combined value n₀(t) of angular velocities at each time point t by using the angular velocity data (bias-corrected angular velocity data for each time point t). For example, if the angular velocity data items at the time point t are respectively indicated by x(t), y(t), and z(t) the timing detection portion 216 computes the combined value n₀(t) of the angular velocities according to the following Equation (2).

n₀(t)=\sqrt{x(t)²y(t)²+z(t)²} (2)

Next, the timing detection portion 216 converts the combined value n₀(t) of the angular velocities at each time point t into a combined value n(t) which is normalized (scale-conversion) within a predetermined range. For example, if the maximum value of the combined value of the angular velocities in an acquisition period of measured data is max (n₀), the timing detection portion 216 converts the combined value n₀(t) of the angular velocities into the combined value n(t) which is normalized within a range of 0 to 100 according to the following Equation (3).

$$n ( t ) = \frac{100 \times {n}_{0} ( t )}{max ( {n}_{0} )} \qquad ( 3 )$$

Next, the timing detection portion 216 computes a derivative dn(t) of the normalized combined value n(t) at each time point t. For example, if a cycle for measuring three-axis angular velocity data items is indicated by Δt, the timing detection portion 216 computes the derivative (difference) dn(t) of the combined value of the angular velocities at the time point t by using the following Equation (4).

dn(t)=n(t)−n(t−Δt) (4)

Next, of time points at which a value of the derivative dn(t) of the combined value becomes the maximum and the minimum, the timing detection portion 216 specifies the earlier time point as an impact time point t_{impact} (impact timing). The timing detection portion 216 can capture a timing at which a derivative value of the combined value of the angular velocities is the maximum or the minimum (that is, a timing at which the derivative value of the combined value of the angular velocities is a positive maximum value or a negative minimum value) in a series of swing actions as the impact timing. Since the golf club 3 vibrates due to the impact, a timing at which a derivative value of the combined value of the angular velocities is the maximum and a timing at which a derivative value of the combined value of the angular velocities is the minimum may occur in pairs, and, of the two timings, the earlier timing may be the moment of the impact.

Next, the timing detection portion 216 specifies a time point of a minimum point at which the combined value n (t) is close to 0 before the impact time point t_{impact}, as a top time point tₜₒₚ (top timing). It is considered that, in a typical golf swing, an action temporarily stops at the top after starting the swing, then a swing speed increases, and finally impact occurs. Therefore, the timing detection portion 216 can capture a timing at which the combined value of the angular velocities is close to 0 and becomes the minimum before the impact timing, as the top timing.

Next, the timing detection portion 216 sets an interval in which the combined value n(t) is equal to or smaller than a predetermined threshold value before and after the top time point tₜₒₚ, as a top interval, and detects a last time point at which the combined value n (t) is equal to or smaller than the predetermined threshold value before a starting time point of the top interval, as a swing starting (backswing starting) time point tₛₜₐᵣₜ. It is hardly considered that, in a typical golf swing, a swing action is started from a standing still state, and the swing action is stopped till the top. Therefore, the timing detection portion 216 can capture the last timing at which the combined value of the angular velocities is equal to or smaller than the predetermined threshold value before the top interval as a timing of starting the swing action. The timing detection portion 216 may detect a time point of the minimum point at which the combined value n (t) is close to 0 before the top time point tₜₒₚ as the swing starting time point tₛₜₐᵣₜ.

The timing detection portion 216 may also detect each of a swing starting timing, a top timing, an impact timing by using three-axis acceleration data in the same manner.

### 1-10. Specifying of Shaft Plane

In the present embodiment, for simplification, a size and a shape of the shaft plane SP is not taken into consideration. In a case where a size and a shape of the shaft plane SP is not taken into consideration, the shaft plane SP can be specified by using the above-described inclined angle α.

Specifically, as illustrated in FIG. 8, the shaft plane SP may be specified as a virtual plane including a target line (target hit ball direction; an example of a first axis) and an axis (a central axis of the shaft; an example of a second axis) in the long axis direction of the shaft of the golf club 3 at address (standing still state) of the user 2 before starting a swing. In other words, the shaft plane SP may be specified as a virtual plane obtained by rotating an XY plane about the X axis by the above-described inclined angle α.

### 1-11. Display Screen of Swing Analysis Data

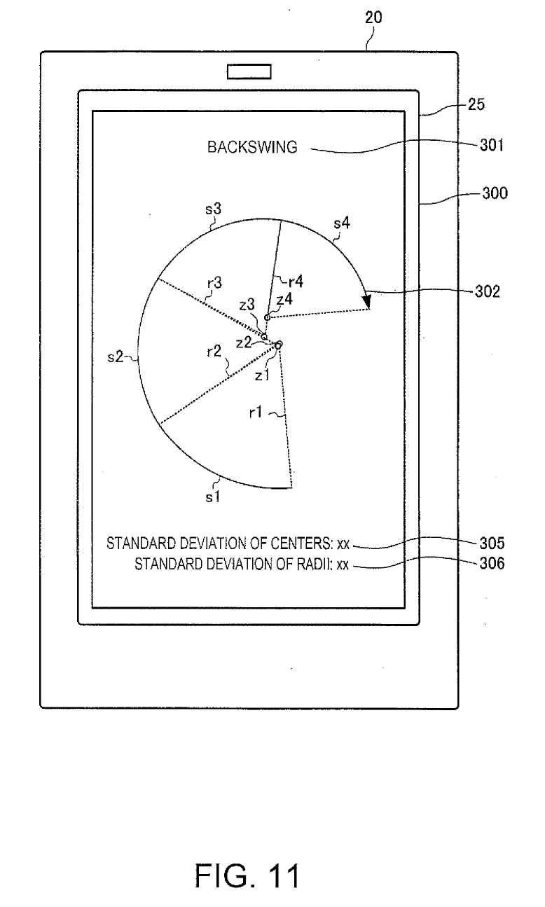

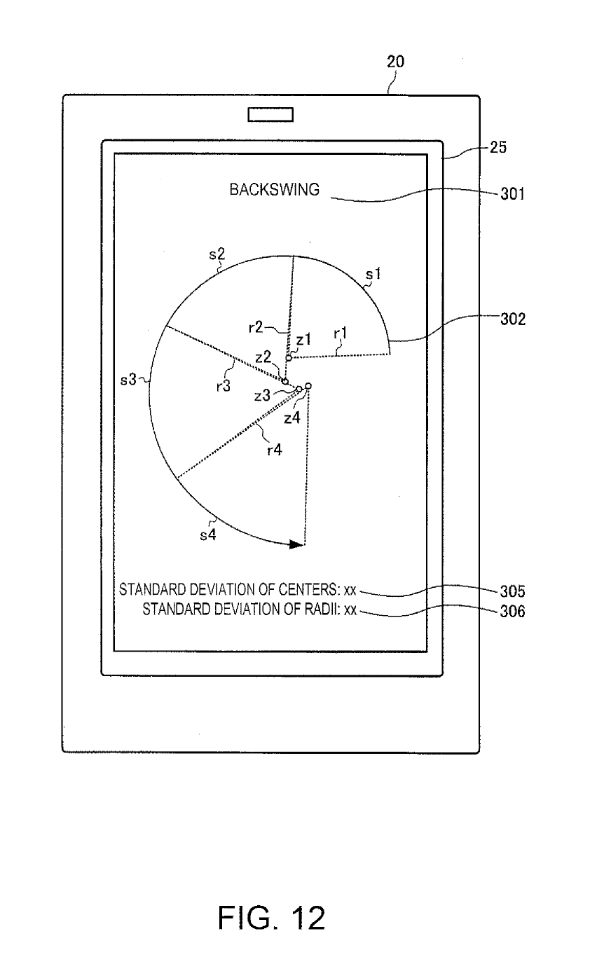

FIG. 11 illustrates an example of a display screen of swing analysis data including indexes calculated through circular arc fitting (a target period is a backswing period). The display screen in FIG. 11 is a screen displayed on the display section 25, for example. At least some of the indexes displayed on the display screen in FIG. 11 may be presented to the user 2 by using a sound or the like output from the sound output section 26 (this is also the same for FIGS. 12, 16 and 18).

A display screen 300 illustrated in FIG. 11 shows the respective indexes when the shaft plane SP is viewed from the front side (when viewed from the front upper side of the user 2).

As illustrated in FIG. 11, a text image 301 indicating a name of a target period of the circular arc fitting, a curve image 302 indicating respective circular arcs of the sections s1, s2, s3 and s4, dot images respectively indicating the circular arc centers z1, z2, z3 and z4, line segment images indicating the respective circular arc radii r1, r2, . . . , a text image 305 indicating the standard deviation σz of the circular arc centers z1, z2, z3 and z4, and a text image 306 indicating the standard deviation σr of the circular arc radii r1, r2, r3 and r4, are disposed on the display screen 300. A line segment image indicating a circular arc radius rn of an n-th section sn is drawn as a line segment from a boundary of the n-th section sn to a circular arc center zn of the n-th section.

Above all, the curve image 302 indicating the respective circular arcs of the sections s1, s2, s3 and s4 indicates an outline of a trajectory of the head projected onto the shaft plane SP. As described above, an overlapping portion is provided in a boundary between sections adjacent to each other, and thus the curve image 302 is smooth since boundaries of the respective circular arcs are continuously disposed.

Here, a trajectory of the head during a backswing is along the shaft plane SP, and thus a trajectory of the head projected onto the shaft plane SP may draw a concentric circle in a case where motion of the backswing does not depend on bending of joints of the elbow or the wrist of the user 2.

Conversely, in a case where a trajectory of the head during the backswing is not along the shaft plane SP, and backswing motion depends on bending of joints of the elbow or the wrist of the user 2, a trajectory of the head projected onto the shaft plane SP may not draw a concentric circle.

Even in a case where backswing motion does not depend on bending of joints of the elbow or the wrist of the user 2, if the centroid of the body of the user 2 moves during the backswing, for example, if the waist of the user 2 is moved (swayed) in a target direction, or the user 2 bends the knees during the backswing, there is a high probability that a trajectory of the head projected onto the shaft plane SP may not draw a concentric circle.

Therefore, if the curve image 302 displayed on the display screen in FIG. 11 has a shape of a concentric circle, a trajectory of the head projected onto the shaft plane SP draws a concentric circle, and thus the user 2 can estimate that the backswing of the user was favorable.

The swaying during the centroid movement is not necessarily bad, but, in the present embodiment, a backswing during which there is no centroid movement without depending on bending on the joints of the elbows or the knees is a fundamentally favorable backswing.

As variations in the circular arc centers z1, z2, z3 and z4 displayed on the display screen in FIG. 11 become smaller, the user 2 can estimate that the extent of concentric circle of the trajectory becomes higher, that is, the backswing of the user becomes more favorable.

If an arrangement direction of the circular arc centers z1, z2, z3 and z4 displayed on the display screen in FIG. 11 is a target direction, the user 2 can recognize that swaying during the backswing occurred. As an arrangement range of the circular arc centers z1, z2, z3 and z4 becomes wider, the user 2 can judge that swaying occurred more greatly.

As variations in the circular arc radii r1, r2, r3 and r4 displayed on the display screen in FIG. 11 becomes smaller, the user 2 can judge that the extent of a true circle of the trajectory becomes higher.

In the display screen in FIG. 11, the circular arc radius rn of the n-th section sn is indicated by the line segment image connecting the boundary of the n-th section sn to the circular arc center zn of the n-th section, and thus the user 2 can intuitively recognize at which sides the boundary of each of the sections s1, s2, s3 and s4 is located.

The text image 305 indicating the standard deviation σz of the circular arc centers z1, z2, z3 and z4 is displayed on the display screen in FIG. 11, and thus the user 2 can quantitatively recognize variations in the circular arc centers z1, z2, z3 and z4.

The text image 306 indicating the standard deviation σr of the circular arc radii r1, r2, r3 and r4 is displayed in FIG. 11, and thus the user 2 can quantitatively recognize variations in the circular arc radii r1, r2, r3 and r4.

FIG. 12 illustrates an example of a display screen of swing analysis data including indexes calculated through circular arc fitting (a target period is a downswing period). In FIG. 12, a difference from FIG. 11 is only a target period of circular arc fitting, and a display aspect of indexes is the same as the display aspect in FIG. 11.

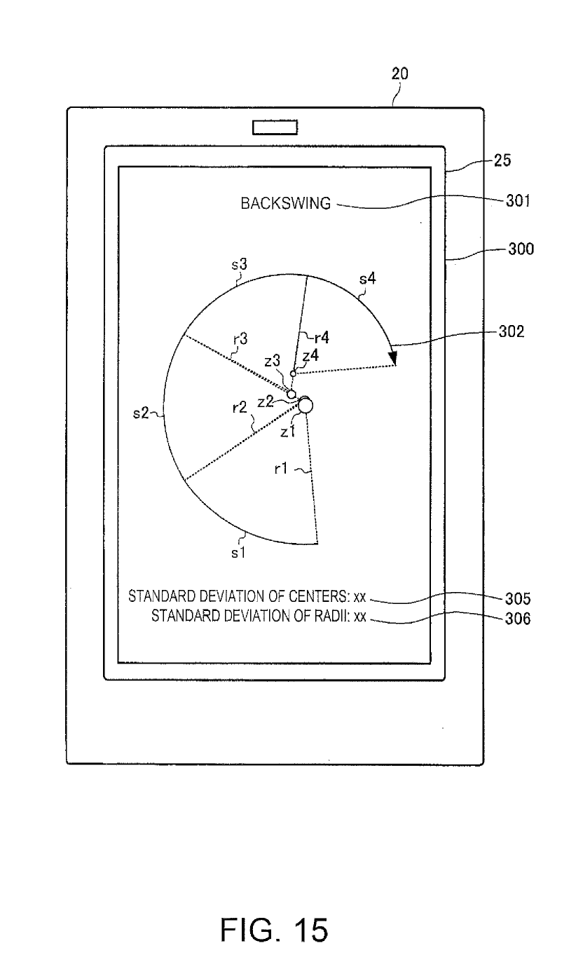

In FIGS. 11 and 12, the circular arcs (curve image 302) of the respective sections are displayed as an outline of a trajectory of the head, but an image in which time-series data (generated by the projection portion 219) projected onto the shaft plane SP is plotted as discrete points (this is also the same for FIGS. 15, 16 and 18 which will be described later).

### 1-12. Calculation of Position of Head

The position calculation portion 217 calculates a position of the head of the golf club 3 as follows. Here, a case where a position of the grip is calculated along with a position of the head will be described as an example.

The position calculation portion 217 computes a position of the head and a position of the grip end at each time point t by using the position and the attitude of the sensor unit 10 at each time point t from the swing start time point tₛₜₐᵣₜ to the impact time point t_{impact}. Specifically, the position calculation portion 217 uses, as a position of the head, a position separated by the distance L_{SH} in the positive direction of the y axis specified by the attitude of the sensor unit 10, from the position of the sensor unit 10 at each time point t, and computes coordinates of the position of the head. As described above, the distance L_{SH} is a distance between the sensor unit 10 and the head. The position calculation portion 217 uses, as a position of the grip end, a position separated by the distance L_{SG} in the negative direction of the y axis specified by the attitude of the sensor unit 10, from the position of the sensor unit 10 at each time point t, and computes coordinates of the position of the grip end. As described above, the distance L_{SG} is a distance between the sensor unit 10 and the grip end.

### 1-13. Detection of Halfway Back and Halfway Down

In the present embodiment, since target periods of circular arc fitting are set to a backswing period and a downswing period, a halfway back timing and a halfway down timing are not necessarily detected, but, in a case where a head or a tail of a target period is halfway back or halfway down, the following detection is necessary.

The timing detection portion 216 may detect a halfway back timing and a halfway down timing by using coordinates of a position of the head and coordinates of a position of the grip end. Specifically, the timing detection portion 216 computes a difference AZ between a Z coordinate of the position of the head and a Z coordinate of the position of the grip end at each time point t from the swing start time point tₛₜₐᵣₜ to the impact time point t_{impact}. The timing detection portion 216 detects a time point t_{HWB} at which a sign of AZ is inverted between the swing start time point tₛₜₐᵣₜ and the top time point tₜₒₚ, as the halfway back timing. The timing detection portion 216 detects a time point t_{HWD} at which a sign of AZ is inverted between the top time point tₜₒₚ and the impact time point t_{impact}, as the halfway down timing.

### 1-14. Circular Arc Fitting

The fitting portion 2111 performs circular arc fitting, for example, according to the following procedures.

First, the fitting portion 2111 defines an XY coordinate system on the shaft plane SP, and defines a circle (circular arc) used for fitting in the following Equation (5).

X²+Y²+AX+BY+C=0 (5)

An XY coordinate system on the shaft plane SP may be selected according to any method (that is, XY coordinates in the shaft plane SP can be set separately from the above-described global coordinate system).

In the circular arc fitting, time-series data included in a target period, that is, coordinates of a position of the head at each time point in the target period are expressed as XY coordinates (Xᵢ, Yᵢ) (where i=1, 2, . . . ) in the shaft plane SP, and are then applied to the left side of the following Equation (6) so that values of coefficients A, B and C causing the left side of Equation (6) to be close to zero are found, A concentric circle specified by the coefficients A, B and C may be used as a fitting result (a circular arc fitted to the time-series data). The fitting using Equation (6) is fitting (least square fitting) using a least square method.

Σ(Xᵢ²+Yᵢ²+AXᵢ+BYᵢ+C)²=0 (6)

Here, if Equation (6) is partially differentiated with A, B, and C, simultaneous equations as in Equation (7) may be obtained.

$$( \begin{matrix}Σ {X}_{i}^{2} & Σ {X}_{i} {Y}_{i} & Σ {X}_{i} \\ Σ {X}_{i} {Y}_{i} & Σ {Y}_{i}^{2} & Σ {Y}_{i} \\ Σ {X}_{i} & Σ {Y}_{i} & Σ1\end{matrix} ) ( \begin{matrix}A \\ B \\ C\end{matrix} ) = ( \begin{matrix}- Σ ( {X}_{i}^{3} + {X}_{i} {Y}_{i}^{2} ) \\ - Σ ( {X}_{i}^{2} {Y}_{i} + {Y}_{i}^{3} ) \\ - Σ ( {X}_{i}^{2} + {Y}_{i}^{2} )\end{matrix} ) \qquad ( 7 )$$

[01′75] Therefore, if the simultaneous equations are solved, values of the coefficients A, B and C can be uniquely calculated.

On the other hand, if position coordinates of a circular arc center is set to (X₀, Y₀), and a circular arc radius is indicated by r, a circle (circular arc) in the XY coordinate system on the shaft plane SP is expressed by the following Equation (8).

(X−X₀)²+(Y−Y₀)²=r² (8)

It can be seen from the above Equations (5) and (8) that the above-described coefficients A, B and C, the position coordinates (X₀,Y₀), and the circular arc radius r have the following relationship.

$${X}_{0} = - \frac{A}{2} \\ {Y}_{0} = - \frac{B}{2} \\ r = \sqrt{{X}_{0}^{2} + {Y}_{0}^{2} - C} \qquad ( 9 )$$

Therefore, first, the fitting portion 2111 applies the time-series data in the target period, that is, the position coordinates (Xᵢ, Yᵢ) (where i=1, 2, . . . ) of the head at the respective time points of the target period to Equation (7) so as to generate simultaneous equations, and calculates values of the coefficients A, B and C by solving the simultaneous equations.

Next, the fitting portion 2111 assigns the calculated values of the coefficients A, B and C to Equation (9) so as to calculate the position coordinates (X₀, Y₀) of the circular arc center, and the circular arc radius r.

### 1-15. Flow of Swing Analysis Process

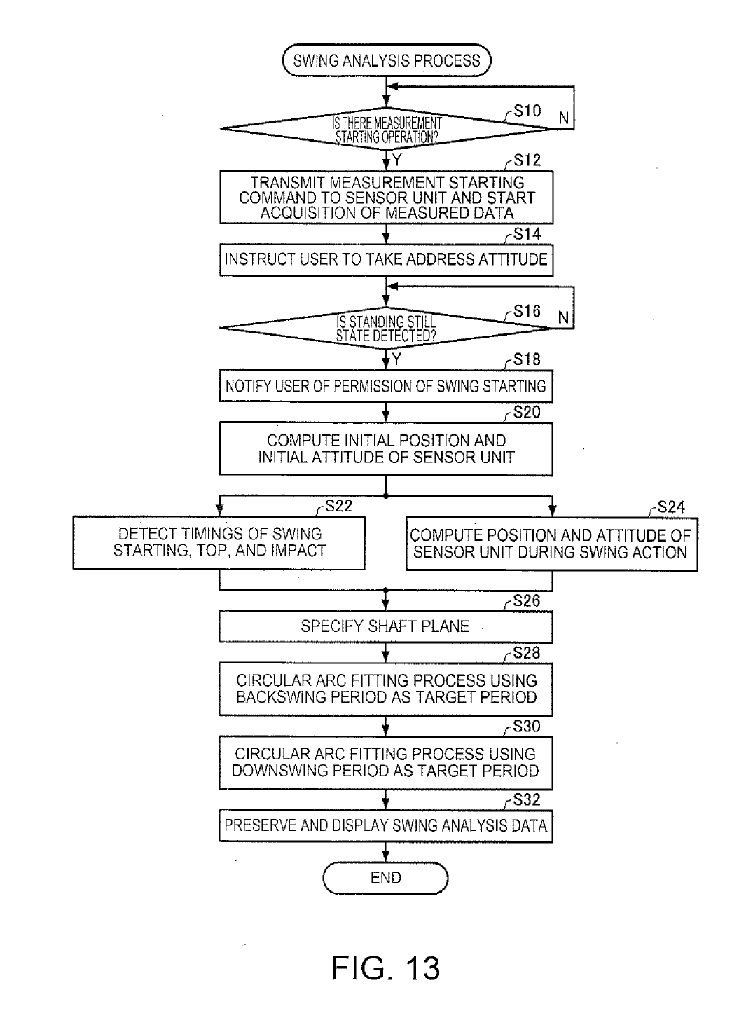

FIG. 13 is a flowchart illustrating examples of procedures of a swing analysis process performed by the processing section 21. The processing section 21 performs the swing analysis process, for example, according to the procedures shown in the flowchart of FIG. 13 by executing the swing analysis program 240 stored in the storage section 24. Hereinafter, the flowchart of FIG. 13 will be described.

Step S10: The processing section 21 waits for the user 2 to perform a measurement starting operation (N in S10), and proceeds to the next step S12 if the measurement starting operation is performed (Y in S10).

Step S12: The processing section 21 transmits a measurement starting command to the sensor unit 10, and starts to acquire measured data from the sensor unit 10.

Step S14: The processing section 21 instructs the user 2 to take an address attitude. The user 2 takes the address attitude in response to the instruction, and stands still.

Step S16: The processing section 21 waits for a standing still state of the user 2 to be detected by using the measured data acquired from the sensor unit 10 (N in S16), and proceeds to step 918 if the standing still state is detected (Y in 916).

Step S18: The processing section 21 notifies the user 2 of permission of swing starting. The processing section 21 outputs, for example, a predetermined sound, or an LED is provided in the sensor unit 10, and the LED is lighted, so that the user 2 is notified of permission of swing starting. The user 2 confirms the notification and then starts a swing action. The processing section 21 performs processes in step S20 and subsequent steps after completion of the swing action of the user 2, or before completion of the swing action.

Step 920: The processing section 21 computes an initial position and an initial attitude of the sensor unit 10 by using the measured data (measured data during standing still (at address) of the user 2) acquired from the sensor unit 10.

Step S22: The processing section 21 detects a swing starting timing, a top timing, and an impact timing by using the measured data acquired from the sensor unit 10.

Step S24: The processing section 21 computes a position and an attitude of the sensor unit 10 during the swing action of the user 2 in parallel to the process in step S22, or before and after the process in step S22. In step S24 of the present embodiment, a position or the like of the head which is a circular arc fitting target portion is also computed.

Step 926: The processing section 21 specifies the shaft plane SP by using the measured data (measured data during standing still (at address) of the user 2) acquired from the sensor unit 10.

Step S28: The processing section 21 performs a circular arc fitting process with a backswing period as a target period. A flow of the circular arc fitting process will be described later.

Step S30: The processing section 21 performs a circular arc fitting process with a downswing period as a target period. A flow of the circular arc fitting process will be described later.

Step S32: The processing section 21 preserves and displays swing analysis data including indexes calculated through the circular arc fitting in steps S28 and S30 and conditions for the circular arc fitting. The processing section 21 finishes the flow of the swing analysis process.

In the flowchart of FIG. 13, order of the respective steps may be changed as appropriate within an allowable range, some of the steps may be omitted or changed, and other steps may be added thereto.

### 1-16. Flow of Circular Arc Fitting Process

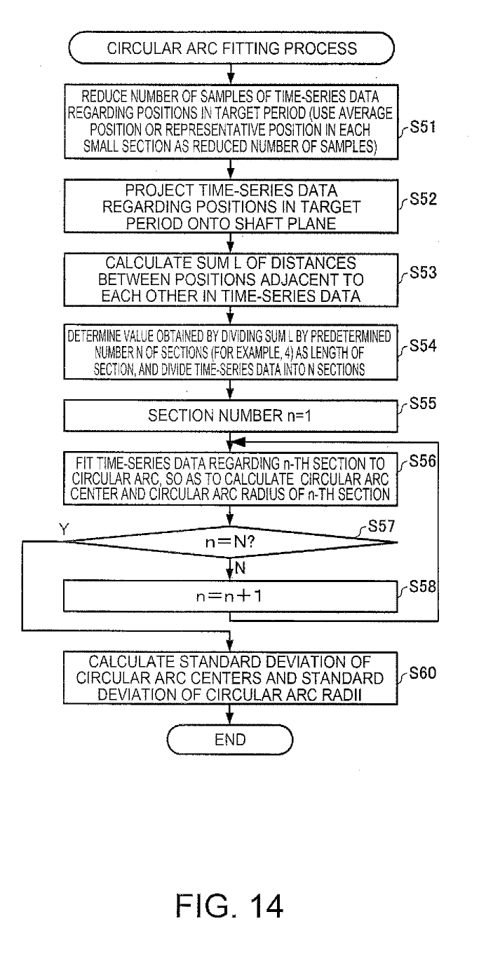

FIG. 14 is a flowchart illustrating examples of procedures of a circular arc fitting process (an example of a swing analysis method) performed by the processing section 21. The processing section 21 performs the circular arc fitting process, for example, according to the procedures shown in the flowchart of FIG. 14 by executing the circular arc fitting program 249 stored in the storage section 24. Hereinafter, the flowchart of FIG. 14 will be described.

Step S51: The processing section 21 extracts time-series data in a target period from time-series data regarding positions of the head, so as to reduce the number of samples of the extracted time-series data. For example, an average position or a representative position in each small section is used as a reduced number of samples.

Step S52: The processing section 21 projects the time-series data regarding the positions in the target period onto the shaft plane.

Step S53: The processing section 21 calculates a sum L of distances between positions adjacent to each other in the time-series data.

Step S54: The processing section 21 determines a value obtained by dividing the sum L by the number N of sections (for example, 4) as a length of the section, and divides the time-series data into N sections.

Step S55: The processing section 21 sets a section number n to (1) as an initial value.

Step S56: The processing section 21 fits time-series data regarding an n-th section to a circular arc, so as to calculate the circular arc center zn and the circular arc radius rn of the n-th section.

Step S57: The processing section 21 determines whether or not the section number n reaches the number N of sections, proceeds to step S60 if the section number n reaches the number N of sections (Y in S57), and proceeds to step S58 if the section number n does not reach the number N of sections (N in S57).

Step S58: The processing section 21 increases the section number n by 1, and proceeds to step S56.

Step S60: The processing section 21 calculates a standard deviation σz of circular arc centers z1, z2, . . . , and zN of the N sections and a standard deviation ar of circular arc radii r1, r2, . . . , and rN of the N sections, and finishes the flow.

In the flowchart of FIG. 14, order of the respective steps may be changed as appropriate within an allowable range, some of the steps may be omitted or changed, and other steps may be added thereto. For example, step S51 may be omitted.

### 2. Modification Examples of Embodiment

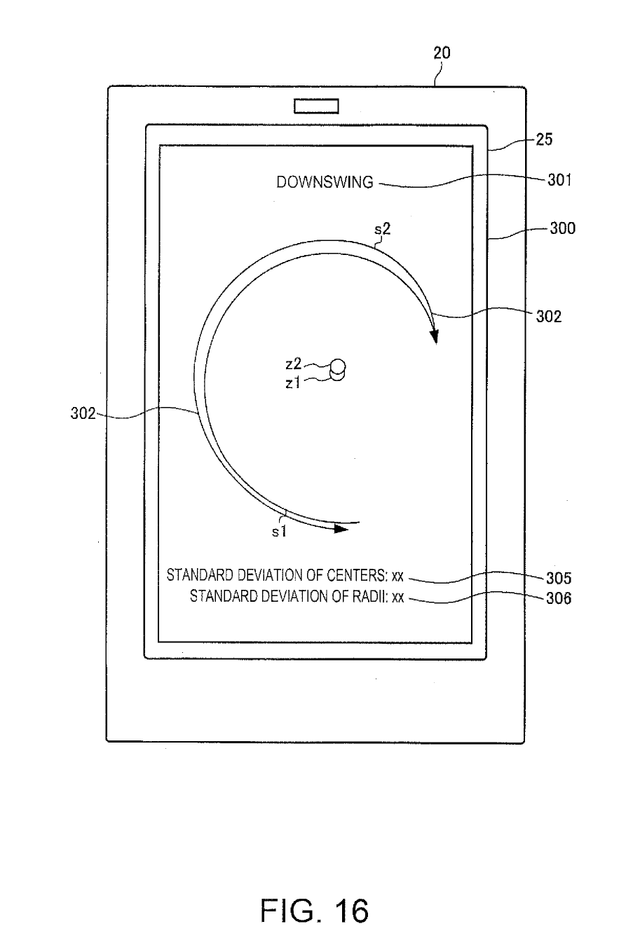

As illustrated in FIGS. 15 and 16, on the display screen of the above-described embodiment, as the circular arc radius rn of the n-th section becomes larger, a size of the dot mark indicating the circular arc center zn may be displayed to become larger. In this case, the user 2 can recognize a size of the circular arc radius on the basis of a size of the displayed dot mark. In the display screens illustrated in FIGS. 15 and 16, even if a line segment indicating the circular arc radius rn is not displayed, the user 2 can recognize a rough size of the circular arc radius rn. In FIGS. 15 and 16, the same elements as in FIG. 11 are given the same reference numerals.

The processing section 21 of the above-described embodiment displays circular arc fitting results for the backswing and circular arc fitting results for the downswing on separate screens (FIGS. 11 and 12), but may display the results on the same screen. In this case, the user 2 can compare indexes regarding the backswing with indexes regarding the downswing.

The processing section 21 of the above-described embodiment sets a backswing period and a downswing period as target periods, and performs circular arc fitting for each section, but may set the entire swing period as a target period, and may perform circular arc fitting for each section. In this case, each of the backswing period and the downswing period may be set as a single section.

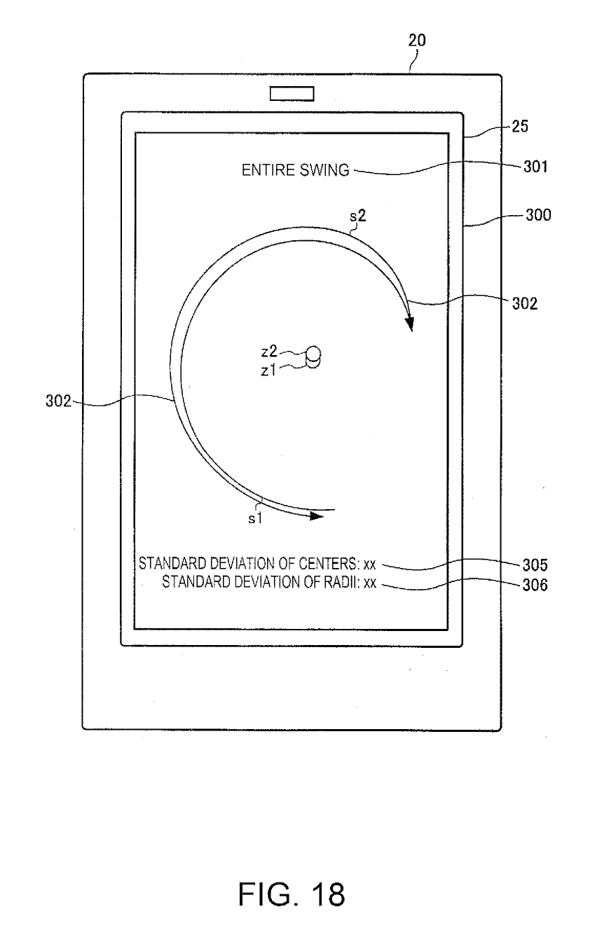

In a case where the entire swing period is set as a target period, and each of the backswing period and the downswing period is set as a single section, a display screen is as illustrated in FIG. 18, for example. On the display screen in FIG. 18, a trajectory indicated by the reference sign s1 is a trajectory in a leading section (backswing period), and a trajectory indicated by the reference sign s2 is a trajectory in a subsequent section (downswing period). In FIG. 18, the same elements as in FIG. 11 are given the same reference numerals.

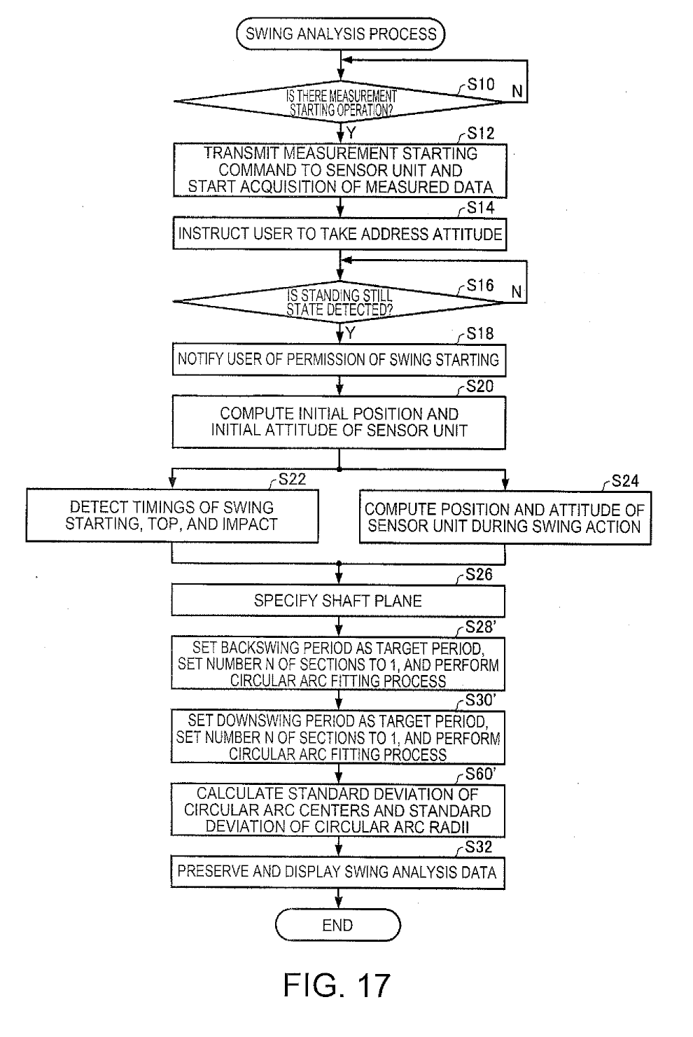

In a case where the entire swing period is set as a target period, and each of the backswing period and the downswing period is set as a single section, the processing section 21 may perform, for example, a flow illustrated in FIG. 17 instead of the flow illustrated in FIG. 13. In FIG. 17, the same elements as in FIG. 13 are given the same reference numerals.

In the flow illustrated in FIG. 17, steps S28′, S30′ and S60′ are executed instead of steps S28 and S30 in the flow illustrated in FIG. 13. Steps S28′, S30′ and S60′ are as follows.

Step S28′: The processing section 21 sets a backswing period as a target period, sets the number N of sections to 1, and performs the circular arc fitting process. Consequently, a circular arc center and a circular arc radius are obtained in a state in which the backswing period is set as a single section.

Step S30′: The processing section 21 sets a downswing period as a target period, sets the number N of sections to 1, and performs the circular arc fitting process. Consequently, a circular arc center and a circular arc radius are obtained in a state in which the downswing period is set as a single section.

Step S60′: The processing section 21 calculates a standard deviation σz of the circular arc center in the backswing period and the circular arc center in the downswing period, and a standard deviation car of the circular arc radius in the backswing period and the circular arc radius in the downswing period, and finishes the flow.

### 3. Appendixes of Embodiment

### 3-1. Appendix of Target Portion

The processing section 21 of the above-described embodiment sets the head of the golf club 3 as a target portion of circular arc fitting, and may use other portions of the golf club 3, for example, the grip, the grip end, and an intermediate location between the grip end and the grip, and may use portions of the body of the user 2, for example, the hand, the wrist, the upper arm, the lower arm, and the shoulder.

In a case where a target portion of circular arc fitting is a portion of the body of the user 2, the sensor unit 10 may be attached to any portion of the body of the user 2.

The processing section 21 may restrict the number of target portions of circular arc fitting to one, and may use a plurality of target portions.

### 3-2. Appendix of Target Period

The processing section 21 of the above-described embodiment sets a combination of a backswing period and a downswing period as a target period of circular arc fitting, but may use other combinations. The number of target periods of circular arc fitting is not limited to two, and may be one, or two or larger.

For example, the processing section 21 of the above-described embodiment sets, as a target period of circular arc fitting, one or two or more of a backswing period, a downswing period, the entire swing period (a period from swing starting to impact), a period from swing starting to halfway back, and a period from halfway down to impact.

The processing section 21 of the above-described embodiment may set at least one of target periods of circular arc fitting to other periods. For example, the other periods may be a short period in the vicinity of a top, a short period right before impact, and a short period right after swing starting.

### 3-3. Appendix of Indexes

The processing section 21 of the above-described embodiment calculates indexes such as a circular arc center of each section, a circular arc radius of each section, a standard deviation of circular arc centers, a standard deviation of circular arc radii through circular arc fitting, but may omit calculation of some of the four indexes, and may add other indexes thereto.

The processing section 21 of the above-described embodiment may calculate other indexes which quantitatively indicate a variation, such as a distribution range of circular arc centers, the maximum difference between the circular arc centers, and an average absolute deviation of circular arc centers, in addition to the standard deviation of circular arc centers or instead of the standard deviation. An average position of circular arc centers may be calculated as an index indicating the center of variations.

The processing section 21 of the above-described embodiment may calculate other indexes which quantitatively indicate a variation, such as a distribution range of circular arc radii, the maximum difference between the circular arc radii, and an average absolute deviation of circular arc radii, in addition to the standard deviation of circular arc radii or instead of the standard deviation. An average value of circular arc radii may be calculated as an index indicating the center of variations.

The processing section 21 of the above-described embodiment may acquire swing diagnosis results on the basis of at least one of indexes calculated through circular arc fitting, and may cause the diagnosis results to be included in swing analysis data.

### 3-4. Appendix of User's Designation

The processing section 21 of the above-described embodiment may allow the user 2 to designate a target portion of circular arc fitting, and may allow the user 2 to designate a presentation target portion.

The processing section 21 of the above-described embodiment may allow the user 2 to designate a target period of circular arc fitting, and may allow the user 2 to designate a presentation target period.

The processing section 21 of the above-described embodiment may allow the user 2 to designate a value of the number N of sections in a target period of circular arc fitting.

The processing section 21 of the above-described embodiment may allow the user 2 to designate an index which will be calculated as a result of circular arc fitting, and may allow the user 2 to designate a presentation target index.

A variety of designations performed by the user 2 are executed via, for example, the operation section 23. The content designated by the user 2 is input to the swing analysis apparatus 20 via, for example, the operation section 23, and is recognized by the processing section 21.

### 3-5. Other Appendixes

In the above-described embodiment, a virtual plane (reference plane) serving as a projection destination of time-series data is the first plane (so-called shaft plane) specified by the first axis along a target hit ball direction and the second axis along the longitudinal direction of the exercise equipment before the swing is started, but may be a second plane (so-called Hogan plane) including the first axis and forming a predetermined angle with the first plane, and may be a third plane (shoulder plane) parallel to the first plane.

At least one type of a plurality of circular arcs, centers, and radii may be displayed to overlap at least one of the planes.

The processing section 21 of the above-described embodiment performs circular arc fitting in the shaft plane SP, that is, in a two-dimensional plane (in the XY coordinate system), but may perform the circular arc fitting in a three-dimensional space. In this case, the processing section 21 may calculate, as an index, an axis (rotation axis) which is parallel to a normal of a plane on which a circular arc is present and which passes through the center of the circular arc. In this case, the processing section 21 may calculate and present at least one of a movement direction, a movement amount, an inclination amount, and an inclination direction of a rotation axis in a target period as a variation in the rotation axis in the target period.

### 4. Operations and Effects of Embodiment

(1) A swing analysis apparatus according to the embodiment includes an acquisition portion (position calculation portion) that acquires time-series data regarding positions of a portion (the head, the grip, the grip end, an intermediate location between the grip end and the grip, the hand, the wrist, the upper arm, the lower arm, the shoulder, or the like) moved due to a swing; a projection portion that projects the time-series data onto a virtual plane (shaft plane) specified by a first axis (target line) along a target hit ball direction and a second axis (a central axis of the shaft) along a longitudinal direction of an exercise equipment (golf club) before the swing is started; a division portion that divides the projected time-series data into a plurality of sections; and a fitting portion that fits the time-series data to a circular arc for each section, and calculates at least one of a center and a radius of the circular arc for each section.

In the related art, there is a technique of calculating deviations of a center and a radius of a swing trajectory in a swing plane as indexes, but the indexes do not reflect quality of an attitude of the swing plane.

However, time-series data set as a fitting target by the fitting portion of the embodiment is not data projected onto the swing plane but data projected onto the virtual plane (shaft plane), and thus an index (at least one of the center and the radius of the circular arc of each section) calculated by the fitting portion may reflect quality of an attitude of the swing plane.

Specifically, in a case where an attitude of the swing plane is not appropriate, there is tendency that a swing trajectory projected onto the virtual plane (shaft plane) departs from a circular shape (here, the “circular shape” is assumed to include both of a concentric circle and a true circle), and thus a variation in the center or the radius of the circular arc increases depending on sections. On the other hand, in a case where an attitude of the swing plane is appropriate, there is tendency that a swing trajectory projected onto the virtual plane (shaft plane) is close to a circular shape, and thus a variation in the center or the radius of the circular arc decreases depending on sections.

Therefore, the index (at least one of the center and the radius of the circular arc of each section) related to the embodiment reliably reflects quality of a swing trajectory. Therefore, according to the index (at least one of the center and the radius of the circular arc of each section) related to the embodiment, for example, it is also possible to perform swing diagnosis with high accuracy.

(2) In the swing analysis apparatus according to the embodiment, the division portion provides an overlapping portion in a boundary region of sections adjacent to each other among the plurality of sections (S54).

Therefore, the swing analysis apparatus according to the embodiment may generate circular arcs of the plurality of sections as a consecutive curve. This curve represents an outline of a swing trajectory.

(3) In the swing analysis apparatus according to the embodiment, the division portion sets spatial lengths of the plurality of sections to be the same as each other (S54).

Therefore, the swing analysis apparatus according to the embodiment can make a length of each circular arc of the plurality of sections uniform. Since a speed of the portion during the swing is not uniform, in a case where temporal lengths of the plurality of sections are set to be the same as each other, there is a probability that a length of each circular arc of the plurality of sections may be considerably nonuniform.

(4) In the swing analysis apparatus according to the embodiment, the division portion divides a sum of intervals of positions adjacent to each other in the projected time-series data by a predetermined number, so as to determine a length of each of the plurality of sections (S53 and S54).

Therefore, the swing analysis apparatus according to the embodiment can reliably set spatial lengths of the plurality of sections to be the same as each other.

(5) In the swing analysis apparatus according to the embodiment, the fitting portion applies a least square method to the fitting (S56).

Therefore, the swing analysis apparatus according to the embodiment can increase the reliability by using the well-known method for the fitting.

(6) In the swing analysis apparatus according to the embodiment, the acquisition portion (position calculation portion) reduces the number of samples of positions included in the time-series data (S51).

The swing analysis apparatus according to the embodiment can reduce a calculation amount required in processes such as projection, division, and fitting.

(7) The swing analysis apparatus according to the embodiment further includes a presentation portion (the display section or the sound output section) that presents, for each section, at least either centers or radii of the circular arcs of the plurality of sections (by using dot images or line segment images).

As a variation in at least one of the center and the radius of the circular arc of the section is reduced, a swing trajectory may become more favorable. Therefore, the swing analysis apparatus according to the embodiment can specifically present quality of a swing trajectory. The swing analysis apparatus according to the embodiment may present how at least one of the center and the radius of the circular arc of the section changes over time.

(8) In the swing analysis apparatus according to the embodiment, the presentation portion (the display section or the sound output section) presents a standard deviation of at least either centers or radii of the circular arcs (by using a text image).

Therefore, the swing analysis apparatus according to the embodiment can quantitatively present a variation in at least one of the center and the radius of the circular arc.

(9) In the swing analysis apparatus according to the embodiment, the presentation portion (the display section or the sound output section) presents a curve (curve image) indicating the circular arc.

Therefore, the swing analysis apparatus according to the embodiment can present an outline of a swing trajectory.

(10) In the swing analysis apparatus according to the embodiment, the presentation portion (the display section or the sound output section) displays, as the radius of the circular arc, a line segment reaching the center of the circular arc of the section from a boundary of at least one of the plurality of sections.

Therefore, the swing analysis apparatus according to the embodiment can present a boundary of the section and the circular arc radius of the section by using a common line segment.

(11) In the swing analysis apparatus according to the embodiment, the time-series data is at least one of time-series data from starting of the swing to impact, time-series data from starting of the swing to a top, and time-series data from the top to the impact (refer to the target period exemplified in the appendix of the embodiment).

Therefore, the swing analysis apparatus according to the embodiment can set, as a fitting target or a presentation target, a period from a predetermined timing of the swing to another predetermined timing thereof.

(12) In the swing analysis apparatus according to the embodiment, at least one of the time-series data and the virtual plane (shaft plane) is calculated on the basis of outputs from an inertial sensor (sensor unit).

The inertial sensor (sensor unit) can accurately measure a position of a portion (the head, the grip, the grip end, an intermediate location between the grip end and the grip, the hand, the wrist, the upper arm, the lower arm, the shoulder, or the like) moved due to a swing. Therefore, the swing analysis apparatus according to the embodiment can accurately calculate an index compared with a case of calculating an index on the basis of a swing image or the like.

(13) A swing analysis system according to the embodiment includes the swing analysis apparatus according to the embodiment; and the inertial sensor (sensor unit).

(14) A swing analysis method (circular arc fitting process) according to the embodiment includes an acquisition procedure (S51) of acquiring time-series data regarding positions of a portion (the head, the grip, the grip end, an intermediate location between the grip end and the grip, the hand, the wrist, the upper arm, the lower arm, the shoulder, or the like) moved due to a swing; a projection procedure (S52) of projecting the time-series data onto a virtual plane (shaft plane) specified by a first axis (target line) along a target hit ball direction and a second axis (shaft axis) along a longitudinal direction of an exercise equipment (golf club) before the swing is started; a division procedure (S53 and S54) of dividing the projected time-series data into a plurality of sections; and a fitting procedure (S56) of fitting the time-series data to a circular arc for each section, and calculating at least one of a center and a radius of the circular arc for each section.

In the related art, there is a technique of calculating deviations of a center and a radius of a swing trajectory in a swing plane as indexes, but the indexes do not reflect quality of an attitude of the swing plane.

However, time-series data set as a fitting target in the fitting procedure (S56) of the embodiment is not data projected onto the swing plane but data projected onto the virtual plane (shaft plane), and thus an index (at least one of the center and the radius of the circular arc of each section) calculated in the fitting procedure (S56) may reflect quality of an attitude of the swing plane.

Specifically, in a case where an attitude of the swing plane is not appropriate, there is tendency that a swing trajectory projected onto the virtual plane (shaft plane) departs from a circular shape (here, the “circular shape” is assumed to include both of a concentric circle and a true circle), and thus a variation in the center or the radius of the circular arc increases depending on sections. On the other hand, in a case where an attitude of the swing plane is appropriate, there is tendency that a swing trajectory projected onto the virtual plane (shaft plane) is close to a circular shape, and thus a variation in the center or the radius of the circular arc decreases depending on sections.

Therefore, the index (at least one of the center and the radius of the circular arc of each section) related to the embodiment reliably reflects quality of a swing trajectory. Therefore, according to the index (at least one of the center and the radius of the circular arc of each section) related to the embodiment, for example, it is also possible to perform swing diagnosis with high accuracy.

(15) A swing analysis program (circular arc fitting program) according to the embodiment causes a computer to execute an acquisition procedure (S51) of acquiring time-series data regarding positions of a portion (the head, the grip, the grip end, an intermediate location between the grip end and the grip, the hand, the wrist, the upper arm, the lower arm, the shoulder, or the like) moved due to a swing; a projection procedure (S52) of projecting the time-series data onto a virtual plane (shaft plane) specified by a first axis (target line) along a target hit ball direction and a second axis (a central axis of the shaft) along a longitudinal direction of an exercise equipment (golf club) before the swing is started; a division procedure (S53 and S54) of dividing the projected time-series data into a plurality of sections; and a fitting procedure (S56) of fitting the time-series data to a circular arc for each section, and calculating at least one of a center and a radius of the circular arc for each section.

In the related art, there is a technique of calculating deviations of a center and a radius of a swing trajectory in a swing plane as indexes, but the indexes do not reflect quality of an attitude of the swing plane.

However, time-series data set as a fitting target in the fitting procedure (S56) of the embodiment is not data projected onto the swing plane but data projected onto the virtual plane (shaft plane), and thus an index (at least one of the center and the radius of the circular arc of each section) calculated in the fitting procedure (S56) may reflect quality of an attitude of the swing plane.

Specifically, in a case where an attitude of the swing plane is not appropriate, there is tendency that a swing trajectory projected onto the virtual plane (shaft plane) departs from a circular shape (here, the “circular shape” is assumed to include both of a concentric circle and a true circle), and thus a variation in the center or the radius of the circular arc increases depending on sections. On the other hand, in a case where an attitude of the swing plane is appropriate, there is tendency that a swing trajectory projected onto the virtual plane (shaft plane) is close to a circular shape, and thus a variation in the center or the radius of the circular arc decreases depending on sections.

Therefore, the index (at least one of the center and the radius of the circular arc of each section) related to the embodiment reliably reflects quality of a swing trajectory. Therefore, according to the index (at least one of the center and the radius of the circular arc of each section) related to the embodiment, for example, it is also possible to perform swing diagnosis with high accuracy.

(16) A recording medium according to the embodiment records a swing analysis program causing a computer to execute an acquisition procedure (S51) of acquiring time-series data regarding positions of a portion (the head, the grip, the grip end, an intermediate location between the grip end and the grip, the hand, the wrist, the upper arm, the lower arm, the shoulder, or the like) moved due to a swing; a projection procedure (S52) of projecting the time-series data onto a virtual plane (shaft plane) specified by a first axis (target line) along a target hit ball direction and a second axis (a central axis of the shaft) along a longitudinal direction of an exercise equipment (golf club) before the swing is started; a division procedure (S53 and S54) of dividing the projected time-series data into a plurality of sections; and a fitting procedure (S56) of fitting the time-series data to a circular arc for each section, and calculating at least one of a center and a radius of the circular arc for each section.

In the related art, there is a technique of calculating deviations of a center and a radius of a swing trajectory in a swing plane as indexes, but the indexes do not reflect quality of an attitude of the swing plane.

However, time-series data set as a fitting target in the fitting procedure (S56) of the embodiment is not data projected onto the swing plane but data projected onto the virtual plane (shaft plane), and thus an index (at least one of the center and the radius of the circular arc of each section) calculated in the fitting procedure (S56) may reflect quality of an attitude of the swing plane.

Specifically, in a case where an attitude of the swing plane is not appropriate, there is tendency that a swing trajectory projected onto the virtual plane (shaft plane) departs from a circular shape (here, the “circular shape” is assumed to include both of a concentric circle and a true circle), and thus a variation in the center or the radius of the circular arc increases depending on sections. On the other hand, in a case where an attitude of the swing plane is appropriate, there is tendency that a swing trajectory projected onto the virtual plane (shaft plane) is close to a circular shape, and thus a variation in the center or the radius of the circular arc decreases depending on sections.

Therefore, the index (at least one of the center and the radius of the circular arc of each section) related to the embodiment reliably reflects quality of a swing trajectory. Therefore, according to the index (at least one of the center and the radius of the circular arc of each section) related to the embodiment, for example, it is also possible to perform swing diagnosis with high accuracy.

(17) A swing display apparatus (swing analysis apparatus 20) according to the embodiment displays a plurality of circular arcs based on a trajectory of a predetermined portion of an exercise equipment due to a swing, and at least one of a center and a radius of each of the plurality of circular arcs, in an overlapping manner with a reference plane specified in a standing still state of the exercise equipment.

(18) In the swing display apparatus (swing analysis apparatus 20) according to the embodiment, each of the circular arcs is a curve to which a projection image obtained by projecting the trajectory onto the plane is fitted.

(19) In the swing display apparatus (swing analysis apparatus 20) according to the embodiment, the reference plane is at least one of a first plane (swing plane) specified by a first axis along a target hit ball direction and a second axis along a longitudinal direction of the exercise equipment before the swing is started, a second plane (Hogan plane) including the first axis and forming a predetermined angle with the first plane, and a third plane (shoulder plane) parallel to the first plane.

### 5. Other Modification Examples

The invention is not limited to the present embodiment, and may be variously modified within the scope of the spirit of the invention.

For example, a plurality of sensor units 10 may be attached to the golf club 3 or parts such as the wrist, the arms or the shoulders of the user 2, and the swing analysis apparatus 20 may perform a swing analysis process by using measured data from the plurality of sensor units 10.

In the above-described embodiment, the acceleration sensor 12 and the angular velocity sensor 14 are built into and are thus integrally formed as the sensor unit 10, but the acceleration sensor 12 and the angular velocity sensor 14 may not be integrally formed. Alternatively, the acceleration sensor 12 and the angular velocity sensor 14 may not be built into the sensor unit 10, and may be directly mounted on the golf club 3 or the user 2.

In the above-described embodiments, an inertial sensor (sensor unit 10) of a type of being attached to the golf club 3 has been described, but the inertial sensor (an acceleration sensor and an angular velocity sensor) may be built into the golf club 3.

In the above-described embodiment, the sensor unit 10 and the swing analysis apparatus 20 are separately provided, but may be integrally formed so as to be attached to the golf club 3 or the user 2. The sensor unit 10 may have some of the constituent elements of the swing analysis apparatus 20 along with the inertial sensor (for example, the acceleration sensor 12 or the angular velocity sensor 14).

In other words, some or all of the functions of the swing analysis apparatus 20 may be installed on the sensor unit 10 side, and some of the functions of the sensor unit 10 may be installed on the swing analysis apparatus 20 side.

Some or all of the functions of the swing analysis apparatus 20 may be installed on a network server side (not illustrated). For example, the function of presenting swing analysis data (a function of notifying a user by using a sound, an image, or vibration) may be installed on the swing analysis apparatus 20 side, and the function of generating swing analysis data may be installed on the network server side.

In the above-described embodiments, the swing analysis system analyzing a golf swing has been exemplified, but the invention is applicable to a swing analysis system diagnosing a swing in various sports such as tennis or baseball.

The above-described embodiments and modification examples are only examples, and the invention is not limited thereto. For example, the embodiments and the respective modification examples may be combined with each other as appropriate.

For example, the invention includes substantially the same configuration (for example, a configuration in which functions, methods, and results are the same, or a configuration in which objects and effects are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

The entire disclosure of Japanese Patent Application No. 2015-216760 filed Nov. 4, 2015 is expressly incorporated by reference herein.

What is claimed is:

1. A swing analysis apparatus comprising:
an acquisition portion that acquires time-series data regarding positions of a predetermined portion of an exercise equipment moved due to a swing;
a projection portion that projects the time-series data onto a virtual plane specified by a first axis along a target hit ball direction and a second axis along a longitudinal direction of the exercise equipment before the swing is started;
a division portion that divides the projected time-series data into a plurality of sections; and
a fitting portion that fits the projected time-series data to a circular arc for each section, and calculates at least one of a center and a radius of the circular arc for each section.

2. The swing analysis apparatus according to claim 1,
wherein the division portion provides portions overlapping each other in a boundary region of sections adjacent to each other among the plurality of sections.

3. The swing analysis apparatus according to claim 1,
wherein the division portion sets spatial lengths of the plurality of sections to be the same as each other.

4. The swing analysis apparatus according to claim 3,
wherein the division portion divides a sum of intervals of positions adjacent to each other in the projected time-series data by a predetermined number, so as to determine a length of each of the plurality of sections.

5. The swing analysis apparatus according to claim 1,
wherein the acquisition portion reduces the number of samples of positions included in the time-series data.

6. The swing analysis apparatus according to claim 1, further comprising:
a presentation portion that presents, for each section, at least either centers or radii of the circular arcs of the plurality of sections.

7. The swing analysis apparatus according to claim 6,
wherein the presentation portion presents a standard deviation of at least either centers or radii of the circular arcs.

8. The swing analysis apparatus according to claim 6,
wherein the presentation portion presents a curve representing a circular arc.

9. The swing analysis apparatus according to claim 6,
wherein the presentation portion displays, as the radius of the circular arc, a line segment reaching the center of the circular arc of the section from a boundary of at least one of the plurality of sections.

10. The swing analysis apparatus according to claim 1,
wherein the time-series data is at least one of time-series data from starting of the swing to impact, time-series data from starting of the swing to a top, and time-series data from the top to the impact.

11. The swing analysis apparatus according to claim 1,
wherein at least one of the time-series data and the virtual plane is calculated on the basis of outputs from an inertial sensor.

12. A swing analysis system comprising:
the swing analysis apparatus according to claim 11; and
the inertial sensor.

13. A swing analysis method comprising:
an acquisition procedure of acquiring time-series data regarding positions of a predetermined portion of an exercise equipment moved due to a swing;
a projection procedure of projecting the time-series data onto a virtual plane specified by a first axis along a target hit ball direction and a second axis along a longitudinal direction of the exercise equipment before the swing is started;
a division procedure of dividing the projected time-series data into a plurality of sections; and
a fitting procedure of fitting the projected time-series data to a circular arc for each section, and calculating at least one of a center and a radius of the circular arc for each section.

14. A recording medium recording a swing analysis program causing a computer to execute:
an acquisition procedure of acquiring time-series data regarding positions of a predetermined portion of an exercise equipment moved due to a swing;
a projection procedure of projecting the time-series data onto a virtual plane specified by a first axis along a target hit ball direction and a second axis along a longitudinal direction of the exercise equipment before the swing is started;
a division procedure of dividing the projected time-series data into a plurality of sections; and
a fitting procedure of fitting the projected time-series data to a circular arc for each section, and calculating at least one of a center and a radius of the circular arc for each section.

15. A swing display apparatus that displays a plurality of circular arcs based on a trajectory of a predetermined portion of an exercise equipment due to a swing, and at least one of a center and a radius of each of the plurality of circular arcs, in an overlapping manner with a reference plane specified in a standing still state of the exercise equipment.

16. The swing display apparatus according to claim 15,
wherein each of the circular arcs is a curve to which a projection image obtained by projecting the trajectory onto the plane is fitted.

17. The swing display apparatus according to claim 15,
wherein the reference plane is at least one of a first plane specified by a first axis along a target hit ball direction and a second axis along a longitudinal direction of the exercise equipment before the swing is started, a second plane including the first axis and forming a predetermined angle with the first plane, and a third plane parallel to the first plane.

18. A display method comprising:
displaying a plurality of circular arcs based on a trajectory of a predetermined portion of an exercise equipment due to a swing, and at least one of a center and a radius of each of the plurality of circular arcs, in an overlapping manner with a reference plane specified in a standing still state of the exercise equipment.

19. The display method according to claim 18,
wherein each of the circular arcs is a curve to which a projection image obtained by projecting the trajectory onto the plane is fitted.

20. The display method according to claim 18,
wherein the reference plane is at least one of a first plane specified by a first axis along a target hit ball direction and a second axis along a longitudinal direction of the exercise equipment before the swing is started, a second plane including the first axis and forming a predetermined angle with the first plane, and a third plane parallel to the first plane.

21. The display method according to claim 18,
wherein portions overlapping each other are provided in a boundary region of circular arcs adjacent to each other among the plurality of circular arcs.

22. The display method according to claim 18,
wherein spatial lengths of the plurality of sections are set to be the same as each other.

23. The display method according to claim 18,
wherein the trajectory is at least one of a trajectory from starting of the swing to impact, a trajectory from starting of the swing to a top, and a trajectory from the top to the impact.
